(19) United States
(12) Patent Application Publication
(10) Pub. No.: US 2016/0227549 A1
(43) Pub. Date: Aug. 4, 2016

(54) RADIO DEVICE THAT HAS FUNCTION TO REDUCE PEAK POWER OF MULTIPLEXED SIGNAL

(71) Applicant: FUJITSU LIMITED, Kawasaki-shi (JP)

(72) Inventors: HIDEHARU SHAKO, Yokohama (JP); Hikaru ISHIKAWA, Kawasaki (JP); Akihiko Komatsuzaki, Kawasaki (JP)

(73) Assignee: FUJITSU LIMITED, Kawasaki-shi (JP)

(21) Appl. No.: 14/993,246

(22) Filed: Jan. 12, 2016

(30) Foreign Application Priority Data
Feb. 4, 2015 (JP) 2015-020112

(51) Int. Cl. H04W 72/04; H04W 52/02

(52) U.S. Cl. CPC H04W 72/0473; H04W 52/0261

(57) ABSTRACT

A radio device includes: a peak power reducer that reduces, according to a peak power of a multi-carrier signal obtained by a multiplexing of a plurality of carrier signals, a gain of the carrier signals before the multiplexing; and an output power corrector that corrects a power of the carrier signals before the multiplexing using a power correction value according to an occupied bandwidth of the multi-carrier signal.

### CROSS-REFERENCE TO RELATED APPLICATIONS

This application is based upon and claims the benefit of priority of the prior Japanese Patent Application No. 2015-020112, filed on Feb. 4, 2015, the entire contents of which are incorporated herein by reference.

### FIELD

The embodiments discussed herein are related to a radio device that has a function to reduce a peak power of a multiplexed signal.

### BACKGROUND

In radio communication systems, it is often desirable that transmission signals are linearly amplified without distortion. However, the input/output characteristics of the power amplifier that amplifies a transmission signal, that is, the relationship between the input power and the output power becomes non-linear from linear as the input power increases, and the output power saturates when the input power exceeds a certain power.

In recent radio communication systems, signals transmitted from a radio base station are multi-carrier signals in which a plurality of carrier signals are multiplexed, for example. Examples of respective carrier signals multiplexed in the multi-carrier signal include a Wideband Code Division Multiple Access (WCDMA) signal and an Orthogonal Frequency Division Multiplexing (OFDM) signal. These multi-carrier signals in which a plurality of signals are multiplexed have a larger Peak to Average Power Ratio (PAPR) compared to that of single-carrier signals. If a power amplifier with a high saturation output power and a large backoff adapted for the peak power is used for linear amplification of a signal having a large PAPR, the consumption power of the device including such a power amplifier becomes large, which leads to a larger size of the device. Therefore, a process for reducing the peak power of the signal by clipping or the like is performed in order to reduce the PAPR of the signal. Such techniques for reducing the peak power of the signal are called Crest Factor Reduction (CFR).

Meanwhile, a device described below that performs peak suppression in accordance with a input limit power for a power amplifier has been known. That is, the device is configured to include a power correction value generator and an output power error corrector. Based on the carrier allocation and the peak suppression setting related to either one or both of the number of carrier signals and the frequency arrangement, the power correction value generator obtains a power correction value for minimizing the error in a carrier multiplexed signal with respect to the reference output power value caused by peak power suppression under the corresponding carrier setting. The output power corrector corrects the signal gain before or after the multiplexing of the carrier signals using the power correction value obtained by the power correction value generator.

Meanwhile, a transmitting device described below that transmits OFDM signals has been known. That is, generating means generate a plurality of OFDM signals. Peak suppression means for base band (BB) performs peak suppression for each of the OFDM signals, according to the plurality of OFDM signals generated by the generating means. IF converting means converts the respective OFDM signals for which peak suppression has been performed by the base band peak suppressing means into signals of intermediate frequency (IF frequency). Intermediate frequency peak suppressing means performs peak suppression for each of the signals of intermediate frequency, according to the respective signals of intermediate frequency converted by the IF converting means. Combining means combines the plurality of signals of intermediate frequency for which peak suppression has been performed by the intermediate frequency peak suppressing means. Amplifying means amplifies the output signal from the combining means. The base band peak suppressing means performs the peak suppression using a combined value of the absolute values of the respective OFDM signals as a predicted peak value. In addition, the intermediate frequency peak suppression means performs peak suppression using the absolute value of the combined plurality of signals of intermediate frequency as a predictive peak value.

In addition, a peak suppressor described below that separates a complex transmission signal into a real part signal and an imaginary part signal and performs a peak suppression process for the real part signal with respect to the signal after separation has been known. That is, the peak suppressor is equipped with a sample unit that selects samples corresponding to a prescribed number of samples from the signal after separation and a suppression signal calculator that calculates a peak suppression signal using the selected samples, and the peak suppressor obtains the signal after the peak suppression process according to the peak suppression signal and the signals after separation.

A transmitter described below has been known. That is, baseband limiter means performs a peak reduction process in the base band with respect to digital signals of a plurality of transmitting carriers. Band limiting filter means performs a band limiting process for the digital signals of the respective carriers for which the peak reduction process has been performed. Orthogonal modulation processing means performs an orthogonal modulation process for the digital signals of the respective carriers for which the band limiting process has been performed. Adding means adds the digital signals of the respective carriers for which the orthogonal modulation process has been performed. Intermediate frequency limiter means multiplies the resultant signal of the addition by a window function that is weighted according to the magnitude of the detected peak and performs a peak reduction process. At this time, when a plurality of peak reduction processes overlap, the weighting for later window function is reduced in order to prevent excessive suppression.

Related arts are described in Japanese Laid-open Patent Publication No. 2006-67073, Japanese Laid-open Patent Publication No. 2008-294519, Japanese Laid-open Patent Publication No. 2009-100218, International Publication Pamphlet No. WO 2006/049140.

### SUMMARY

According to an aspect of the embodiments, a radio device includes: a peak power reducer that reduces, according to a peak power of a multi-carrier signal obtained by a multiplexing of a plurality of carrier signals, a gain of the carrier signals before the multiplexing; and an output power corrector that corrects a power of the carrier signals before the multiplexing using a power correction value according to an occupied bandwidth of the multi-carrier signal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A-1C illustrate an example of a radio device according to the first embodiment;

FIG. 2 illustrates an example of a peak reduction value calculator;

FIG. 3 illustrates an example of a power correction value table according to the first embodiment;

FIG. 4A illustrates an example of a multi-carrier signal having a narrow occupied bandwidth to which a peak power suppression process has not been applied;

FIG. 4B illustrates an example of a multi-carrier signal having a broad occupied bandwidth to which a peak power suppression process has not been applied;

FIG. 5 illustrates an example of changes with time in the power of multi-carrier signals;

FIG. 6A illustrates an example of a multi-carrier signal having a narrow occupied bandwidth to which a peak power suppression process has been applied;

FIG. 6B illustrates an example of a multi-carrier signal having a broad occupied bandwidth to which a peak power suppression process has been applied;

FIG. 7 is a flowchart illustrating an example of a transmission process for a multi-carrier signal performed by a radio device according to the first embodiment;

FIG. 8 is an exemplary hardware configuration diagram for a radio device according to the first embodiment;

FIGS. 9A-9B illustrate an example of a radio device according to the second embodiment;

FIG. 10 illustrates an example of a power correction value table according to the second embodiment;

FIG. 11 is a flowchart illustrating an example of a transmission process for a multi-carrier signal performed by a radio device according to the second embodiment;

FIGS. 12A-12B illustrate an example of a radio device according to the third embodiment;

FIG. 13 is a flowchart illustrating an example of a transmission process for a multi-carrier signal performed by a radio device according to the third embodiment;

FIGS. 14A-14B illustrate an example of a radio device according to the fourth embodiment; and

FIG. 15 is a flowchart illustrating an example of a transmission process for a multi-carrier signal performed by a radio device according to the fourth embodiment.

### DESCRIPTION OF EMBODIMENTS

Hereinafter, embodiments of the invention are described with reference to the drawings.

### First Embodiment

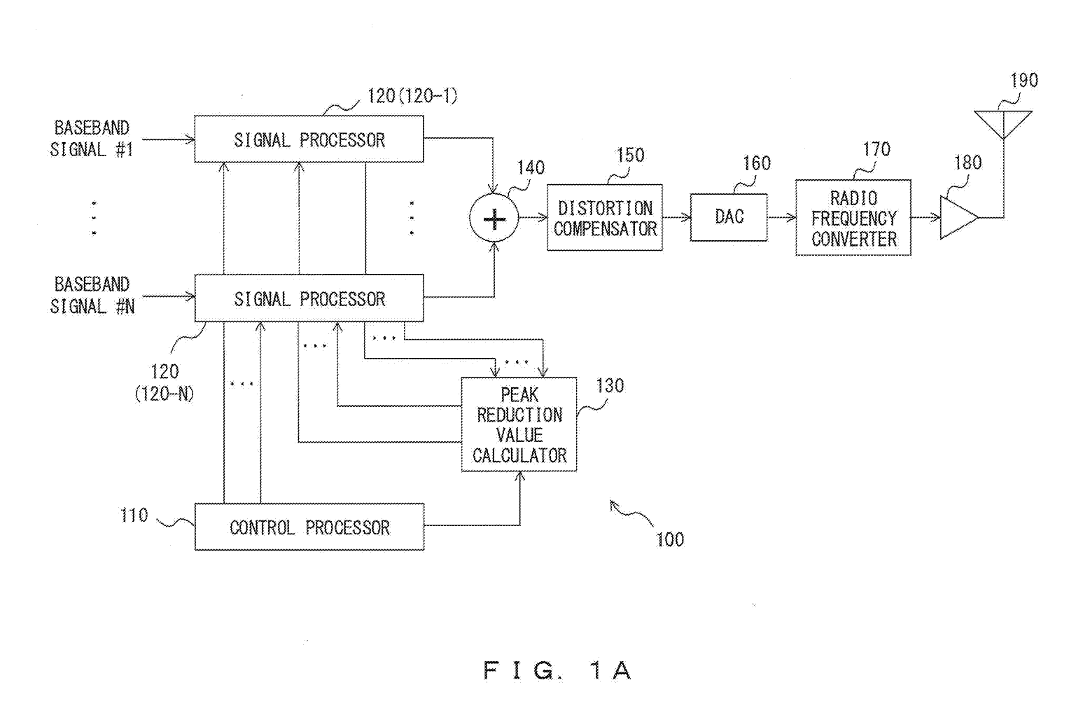

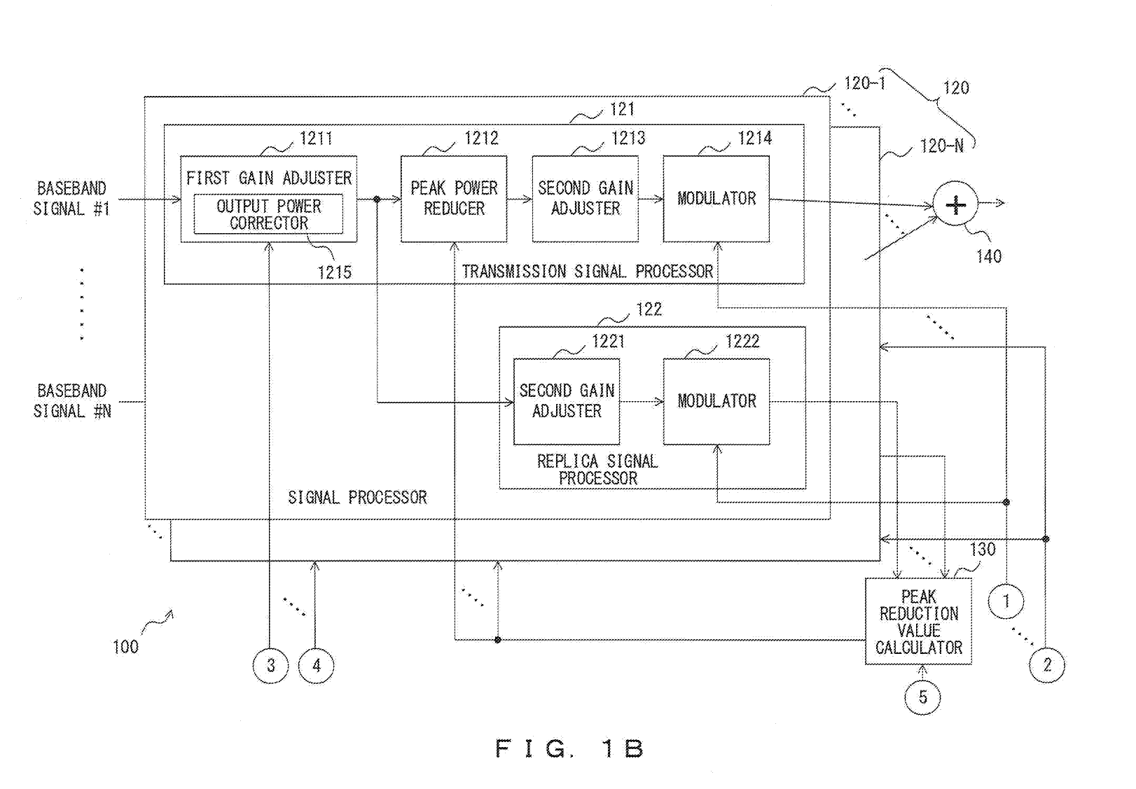

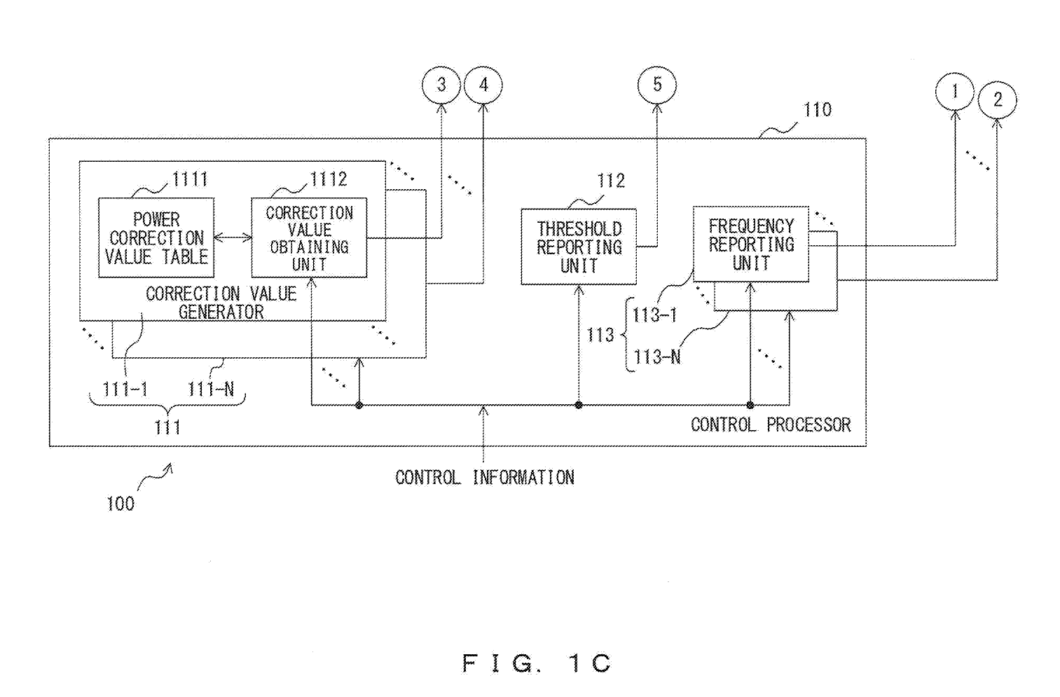

FIGS. 1A-1C are exemplary diagrams for a radio device according to the first embodiment. A radio device 100 according to the first embodiment illustrated in FIGS. 1A-1C may be a part of a radio base station such as evolved Node B (eNodeB) standardized in the specifications of Third Generation Partnership Project (3GPP), for example. In addition, the radio device 100 may be a device called Radio Equipment (RE) or Remote Radio Head (RRH), for example.

As illustrated in FIGS. 1A-1C, the radio device 100 includes a control processor 110, N signal processors 120 (120-1 through 120-N), a peak reduction value calculator 130, a combiner 140, a distortion compensator 150, a Digital to Analog Converter (DAC) 160, a radio frequency converter 170, a power amplifier 180, and an antenna 190. Here, the symbol “N” represents an integer that is 2 or greater and that corresponds to the number of carriers in the multi-carrier signal transmitted from the radio device 100. Meanwhile, when the N identical elements are not to be particularly distinguished in the explanations below, the indication is omitted after the hyphen attached to the reference numerals for the purpose of distinction between the N identical elements. For example, when the signal processors 120-1 through 120-N are not to be particularly distinguished, each of them is described as the signal processor 120.

Each of the signal processors 120-1 through 120-N processes one carrier signal that is different from each other in the N carrier signals to be combined (multiplexed) in the multi-carrier signal. The signal processor 120 generates a corresponding carrier signal according to the instruction from the control processor 110. Specifically, the signal processor 120 performs signal processing for a baseband signal before it is put onto a carrier according to the instruction from the control processor 110, and generate a carrier signal. Meanwhile, in the explanations below, the “baseband signal before it is put onto a carrier” may be referred to as “the baseband signal of a carrier”.

The baseband signals #1 through #N that are respectively processed by the signal processors 120-1 through 120-N are given from an application (not illustrated in the drawing). The application that gives the baseband signals to the signal processors 120 may be a part of the radio base station. In addition, the application may be a device called Radio Equipment Control (REC) or Base Band Unit (BBU), for example.

Baseband signals given from the application to the signal processors 120 may be signals in which complex modulation is applied to a data signal according to a prescribed Radio Access Technology (RAT) with respect to the In-phase component and the Quadrature component. The prescribed radio access technology may be WCDMA, Long Term Evolution (LTE), and LTE-Advanced (LTE-A), or the like. For example, in WCDMA, baseband signals given to the signal processor 120 are WCDMA signals in which a data signal is modulated according to modulation formats such as Quadrature Phase Shift Keying (QPSK) and 16 Quadrature Amplitude Modulation (16QAM) or the like. Meanwhile, in LTE and LTE-A, baseband signals given to the signal processors 120 are OFDM signals in which a data signal is modulated according to modulation formats such as QPSK, 16QAM, and 64QAM or the like for each subcarrier. The N baseband signals may be signal that are respectively generated according to by modulation formats based on different radio access technologies.

The N signal processors 120-1 through 120-N respectively include a transmission signal processor 121 and a replica signal processor 122.

The transmission signal processor 121 includes a first gain adjuster 1211, a peak power reducer 1212, a second gain adjuster 1213, a modulator 1214, and an output power corrector 1215. The output power corrector 1215 may be included in the first gain adjuster 1211.

The first gain adjuster 1211 adjusts the gain of carrier signals multiplexed in a multi-carrier signal so that the transmission output power of the multi-carrier signal transmitted from the antenna 190 via the power amplifier 180 becomes a prescribed reference output power. Specifically, the first gain adjuster 1211 reduces the power of an input baseband signal of a carrier to a prescribed reference output power for the corresponding carrier signal according to a first gain adjustment value reported from the control processor 110.

Meanwhile, in the first embodiment, the first gain adjuster 1211 includes an output power corrector 1215. The output power corrector 1215 corrects the error between the power of a carrier signal to which a peak power reduction process has been applied by the peak power reducer 1212 and the prescribed reference output power for the corresponding carrier signal. Specifically, the output power corrector 1215 corrects the power of an input baseband signal according to a power correction value reported from the control processor 110.

The power correction value may be multiplied by the first gain adjustment value so as to be reported from the control processor 110 to the first gain adjuster 1211 together with the first gain adjustment value. In addition, the first gain adjuster 1211 that includes the output power corrector 1215 may be configured so as to adjust the power of an input baseband signal according to the first gain adjustment value multiplied by the power correction value.

The peak power reducer 1212 reduces the power of the multi-carrier signal in which the respective carrier signals are multiplexed to be equal to or smaller than a prescribed peak power threshold set by the control processor 110, by multiplying the input baseband signal of a carrier by a peak reduction value (reduction coefficient). The peak reduction value is generated by the peak reduction value calculator 130. The peak reduction value calculator 130 calculates the peak reduction value based on a comparison between a replica of the multi-carrier signal and a peak power threshold reported from the control processor 110. The replica of the multi-carrier signal is a signal obtained by combining respective carrier signals to which the process by the peak power reducer 1212 is not applied. The replica of the multi-carrier signal is generated by the process performed by the replica signal processor 122.

The replica signal processor 122 includes a second gain adjuster 1221 and a modulator 1222. The second gain adjuster 1221 has substantially the same function as that of the second gain adjuster 1213. Meanwhile, the modulator 1222 has substantially the same function as that of the modulator 1214. The baseband signal output from the first gain adjuster 1211 is input to the second gain adjuster 1221. The baseband signal whose gain has been adjusted by the second gain adjuster 1221 is input to the modulator 1222. The modulator 1222 performs frequency shift by a carrier frequency reported from the control processor 110 to generate a replica of the carrier signal.

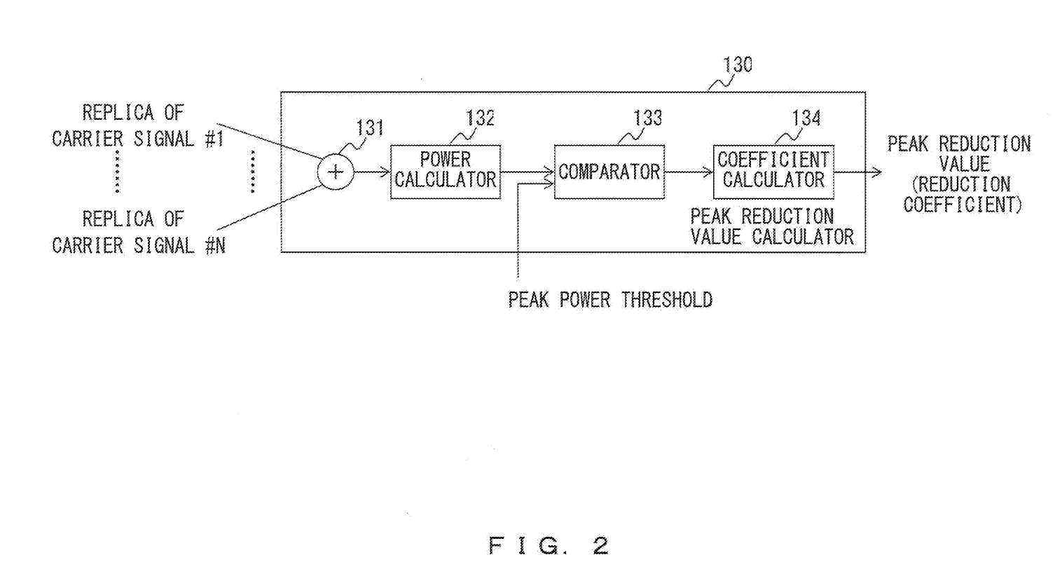

The replicas of carrier signals generated respectively by the modulators 1222 in the signal processors 120-1 through 120-N are input to the peak reduction value calculator 130. FIG. 2 is an exemplary configuration diagram of the peak reduction value calculator 130. As illustrated in FIG. 2, the peak reduction value calculator 130 includes a combiner 131, a power calculator 132, a comparator 133, and a coefficient calculator 134.

The combiner 131 generates a replica of the multi-carrier signal by combining (multiplexing) the replicas of the carrier signals respectively generated by the modulators 1222 in the signal processors 120-1 through 120-N. The power calculator 132 calculates the power value of the multi-carrier signal to which the peak power reduction process by the peak power reducer 1212 has not been applied, using the replica of the multi-carrier signal generated by the synthesizer 131. The comparator 133 compares the power value calculated by the power calculator 132 and the peak power threshold reported from the control processor 110 and detects the different (error) between them. The coefficient calculator 134 calculates the peak reduction value (reduction coefficient) by which the baseband signal of the carrier is to be multiplied in the peak power reducer 1212, according to the detected difference. The calculated peak reduction value is fed to the peak power reducer 1212 of each of the N transmission signal processors 121.

In the N peak power reducers 1212, the baseband signals of the respective carriers are multiplied by the same peak reduction value respectively in the period of time in which the replica of the multi-carrier signal exceeds the peak power threshold. By the reduction process applied to the baseband signal of each carrier by the peak power reducer 1212, the PAPR of the multi-carrier signal in which the respective carrier signals are combined (multiplexed) is reduced.

Meanwhile, in the example illustrated in FIGS. 1A-1C, the peak reduction value calculator 130 calculates the peak reduction value using the replica of the multi-carrier signal treated with a correction according to the power correction value. That is, in the example illustrated in FIGS. 1A-1C, the replica of the carrier signal treated with a power correction by the output power corrector 1215 is generated by each replica signal processor 122, and the generated replica signal of each carrier is input to the peak reduction value calculator 130. However, the peak reduction value calculator 130 may be configured so as to calculate the peak reduction value using the replica signal of the multi-carrier signal that is not treated with the correction according to the power correction value. In this case, each replica signal processor 122 may be configured so as to generate a replica of the carrier signal that is not treated with the correction according to the power correction value. Specifically, each replica signal processor 122 may be configured to further include a gain adjuster having substantially the same function as that of the first gain adjuster 1211 that does not include the output power corrector 1215. The same baseband signal as the baseband signal that is input to the first gain adjuster 1211 is input to the gain adjuster added to each replica signal processor 122. Then, the baseband signal that is output from the added gain adjuster is input to the second gain adjuster 1221.

The second gain adjuster 1213 adjusts the gain of the carrier signal included in the multi-carrier signal so that the multi-carrier signal before conversion to radio frequency is converted from digital to analog at the optimal operation point of the digital to analog converter 160. Specifically, the second gain adjuster 1213 increases the power of an input baseband signal according to a second gain adjustment value. The second gain adjustment value is set in advance in the second gain adjuster 1213.

The modulator 1214 applies frequency shift by a carrier frequency reported from the control processor 110 to the baseband signal whose gain has been adjusted by the second gain adjuster 1213 and generates a carrier signal. The modulator 1214 includes an oscillator such as Numerically Controlled Oscillator (NCO), for example.

The combiner 140 combines the carrier signals respectively generated by the modulators 1214 in the signal processors 120-1 through 120-N and generates a multi-carrier signal. The respective carrier signals multiplexed in the generated multi-carrier signal are arranged at a prescribed frequency spacing according to the respective carrier frequencies. The distortion compensator 150 compensates for the distortion of the multi-carrier signal generated due to the amplification of the power of the multi-carrier signal by the power amplifier 180. The digital to analog converter 160 converts the multi-carrier signal that has been through the process performed by the distortion compensator 150 from digital to analog. The radio frequency converter 170 converts the multi-carrier signal that has been converted into analog to a signal of prescribed radio frequency. The power amplifier 180 amplifies the transmission output power of the multi-carrier signal of radio frequency to a prescribed reference output power. The antenna 190 emits the multi-carrier signal whose transmission output power has been amplified by the power amplifier 180 into the space outside the radio device 100.

The control processor 110 controls the processes of the signal processor 120. Specifically, the control processor 110 receives control information for each carrier signal from a host device (not illustrated in the drawing). The control information includes the carrier frequency information, the first gain adjustment value, and the radio access technology (RAT) information.

The control processor 110 generates control values for controlling the processes of the signal processor 120 using the received control information. Control values include the first gain adjustment value, the peak power threshold, the carrier frequency information, and the power correction value. A value obtained by multiplying the first gain adjustment value by the power correction value may be generated as the first gain adjustment value and the power correction value. The control processor 110 makes the signal processor 120 execute processes according to the generated control values. Specifically, the control processor 110 gives the first gain adjustment value, the carrier frequency information, and the power correction value to the signal processor 120. The value obtained by multiplying the first gain adjustment value by the power correction value may be given to the signal processor 120 as the first gain adjustment value and the power correction value. In addition, the control processor 110 gives the peak power threshold to the peak reduction value calculator 130.

The control processor 110 includes correction value generators 111-1 through 111-N, a threshold reporting unit 112, and frequency reporting units 113-1 through 113-N.

For the correction value generators 111-1 through 111-N, the processing target for each is one carrier signal that is different from each other in the N carrier signals multiplexed in a multi-carrier signal. The correction value generator 111 receives the first gain adjustment value for the processing-target carrier signal from the host device. In addition, the correction value generator 111 receives information of the carrier frequency for each of the carrier signals multiplexed in the multi-carrier signal from the host device. The correction value generator 111 generates the power correction value for the processing-target carrier signal using the received information of the carrier frequency. The correction value generator 111 multiplies the first gain adjustment value by the generated power correction value. The correction value generator 111 transmits the first gain adjustment value multiplied by the power correction value to the first gain adjuster 1211 provided for the corresponding carrier signal.

The threshold reporting unit 112 receives the information of the radio access technology (RAT) for the transmission-target multi-carrier signal from the host device. The threshold reporting unit 112 gives a prescribed peak power threshold according to the radio access technology to the peak reduction value calculator 130.

For the frequency reporting units 113-1 through 113-N, the processing target for each is one carrier signal that is different from each other in the N carrier signals multiplexed in the multi-carrier signal. The frequency reporting unit 113 reports the carrier frequency of the processing-target carrier signal to the modulator 1214 and the modulator 1222 in the signal processor 120 provided for the corresponding carrier signal. Specifically, the frequency reporting unit 113 receives information of the carrier frequency of the processing-target carrier signal from the host device. The frequency reporting unit 113 gives the carrier frequency information to the modulator 1214 and the modulator 1222 in the signal processor 120 provided for the corresponding carrier signal.

The correction value generators 111-1 through 111-N respectively include a power correction value table 1111 and a correction value obtaining unit 1112.

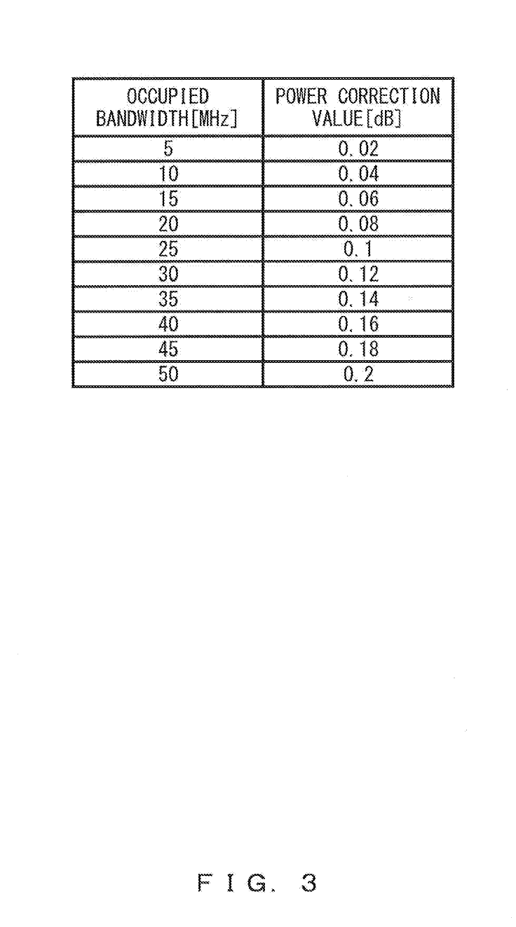

FIG. 3 is an exemplary diagram of a power correction value table according to the first embodiment. As illustrated in FIG. 3, the power correction value is recorded in a power correction value table 1111 with respect to occupied bandwidth of the multi-carrier signal. The occupied bandwidth of a multi-carrier signal represents the frequency bandwidth between the lowest carrier frequency and the highest carrier frequency in the carrier frequencies of a plurality of (N) carrier signals multiplexed in the multi-carrier signal. The example of the content in FIG. 3 indicates that the broader the occupied bandwidth, the larger the gain (power correction value) added by the output power corrector 1215. Meanwhile, the power correction value table in the present embodiment is not limited to the example of the content in FIG. 3, and an arbitrary power correction value may be set for each occupied bandwidth of a multi-carrier signal. In addition, the segments of the occupied bandwidths are not limited to those in the example of the content in FIG. 3, and they may be set arbitrarily.

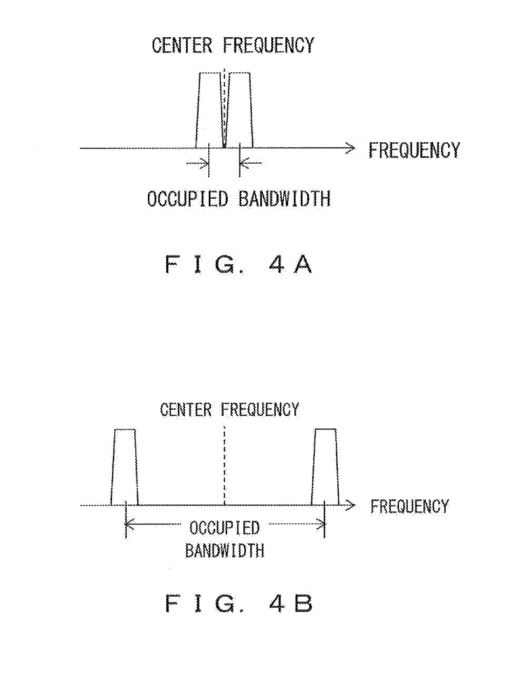

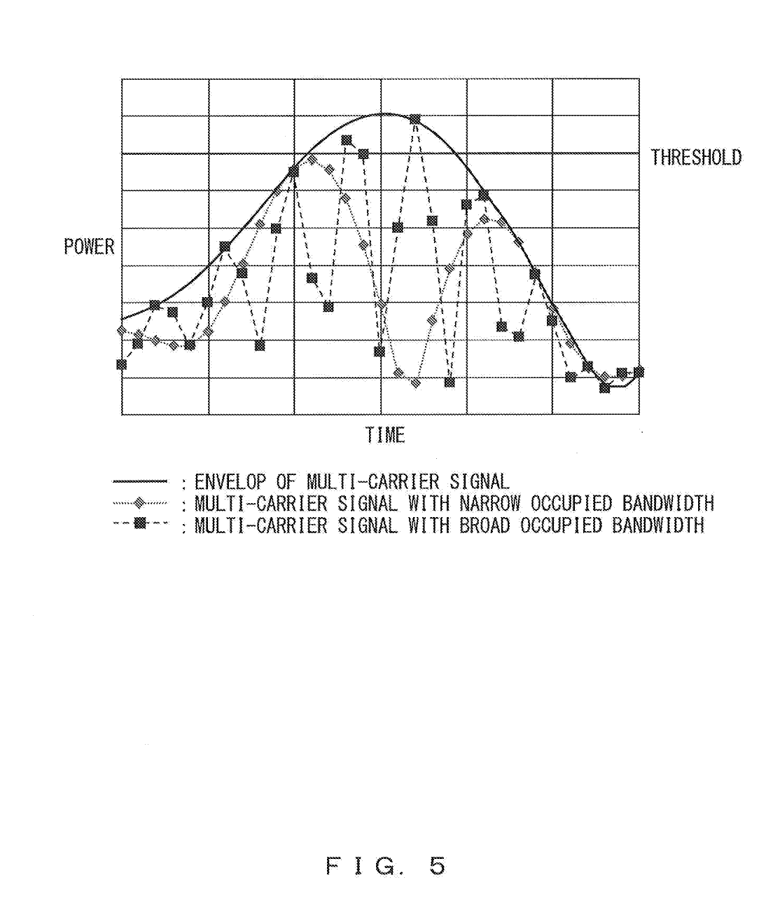

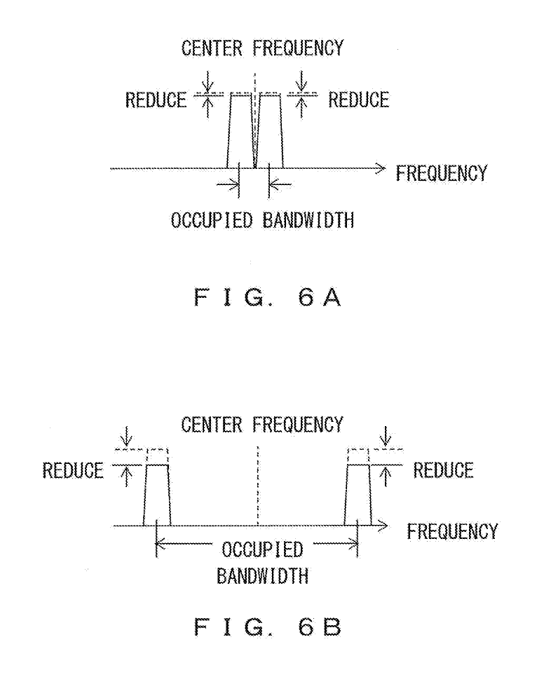

The reason why the power correction value is recorded in the power correction value table 1111 for each occupied bandwidth of the multi-carrier signal is explained below with respect to FIG. 4A, FIG. 4B, FIG. 5, FIG. 6A, and FIG. 6B.

FIG. 4A is an exemplary diagram of a multi-carrier signal having a narrow occupied bandwidth for which the peak power suppression process has not been applied. FIG. 4B is an exemplary diagram of a multi-carrier signal having a broad occupied bandwidth for which the peak power suppression process has not been applied. FIG. 4A and FIG. 4B present exemplary illustrations of multi-carrier signals in which two (N=2) carrier signals are combined (multiplexed). In addition, the multi-carrier signals illustrated in FIG. 4A and FIG. 4B represent signals in which carrier signals to which the peak power reduction process has not been applied by the peak power reducer 1212 in the signal processor 120. Note that the occupied bandwidth of the multi-carrier signal may be narrow in accordance with the carrier frequencies of the respective carrier signals as in FIG. 4A in some cases, and it may be broad as in FIG. 4B in some cases.

FIG. 5 is an exemplary diagram of changes with time in the power of multi-carrier signals. FIG. 5 illustrates changes with time in the power of a multi-carrier signal having a narrow occupied bandwidth as in FIG. 4A and changes with time in the power of a multi-carrier signal having a broad occupied bandwidth as in FIG. 4B together with the envelope of the multi-carrier signals. As illustrated in FIG. 5, changes with time in the power of the multi-carrier signal having a broad occupied bandwidth are faster compared with changes with time in the power of the multi-carrier signal having a narrow occupied bandwidth. That is, the multi-carrier signal having a narrow occupied bandwidth follows the envelope over relatively long time intervals, whereas the multi-carrier signal having a broad occupied bandwidth follows the envelope over relatively short time intervals.

The reason why the multi-carrier signal having abroad occupied bandwidth follows the envelope over relatively short time intervals compared with the multi-carrier signal having a narrow occupied bandwidth may be explained as follows for example. That is, when there is a carrier signal of higher frequency assuming the carrier signal of low frequency multiplexed in the multi-carrier signal as a reference, that is, when there is a carrier signal whose amplitude changes faster with time, the multi-carrier signal includes a component whose amplitude changes faster with time. For this reason, the changes with time in the amplitude (power) of the multi-carrier signal becomes faster when there is a carrier signal of a higher frequency with respect to the carrier signal at the low-frequency side, that is, when the occupied bandwidth of the multi-carrier is broader.

As described above, changes with time in multi-carrier signals differ according to the width of the occupied bandwidth of the multi-carrier signals. Specifically a multi-carrier signal having a broad occupied bandwidth follows the envelope over relatively short time intervals, and therefore, a multi-carrier signal having a broad occupied bandwidth includes a signal having a large power compared with a the multi-carrier signal having a narrow occupied bandwidth. For this reason, when a reduction process such as clipping or the like is applied in the same manner using a peak power threshold such as the one illustrated in FIG. 5, the power of the signal regarded as the target of the reduction process as the signal that exceeds the peak power threshold differs according to the width of the occupied bandwidth of the multi-carrier signals.

Specifically, a multi-carrier signal having a narrow occupied bandwidth follows the envelope over relatively long time intervals as illustrated in FIG. 5. For this reason, in a multi-carrier signal having a narrow occupied bandwidth, the power of the signal regarded as the target of the reduction process as the signal that exceeds the peak power threshold is relatively small. Therefore, when the reduction process is applied using the same peak power threshold as that for a multi-carrier signal having a broad occupied bandwidth, the power reduced in the multi-carrier signal having a narrow occupied bandwidth is relatively small as illustrated in FIG. 6A. FIG. 6A is an exemplary diagram of a multi-carrier signal having a narrow occupied bandwidth to which a peak power reduction process has been applied.

On the other hand, a multi-carrier signal having a broad occupied bandwidth follows the envelope over relatively short intervals as illustrated in FIG. 5. For this reason, in a multi-carrier signal having a broad occupied bandwidth, the power of the signal regarded as the target of the reduction process as the signal that exceeds the peak power threshold is relatively large. Therefore, when the reduction process is applied using the same peak power threshold as that for a multi-carrier signal having a narrow occupied bandwidth, the power reduced in the multi-carrier signal having a broad occupied bandwidth is relatively large as illustrated in FIG. 6B. FIG. 6B is an exemplary diagram of a multi-carrier signal having a broad occupied bandwidth to which a peak power reduction process has been applied.

Thus, the magnitude of the power to which the reduction process is applied in each carrier signal differs according to the width of the occupied bandwidth of the multi-carrier signal, when the process is to be applied using the same peak reduction value (reduction coefficient). Specifically, the power reduced by the process performed by the peak power reducer 1212 becomes larger as the occupied bandwidth of the multi-carrier signal becomes wider.

Meanwhile, FIG. 4A, FIG. 4B, FIG. 5, FIG. 6A, and FIG. 6B are merely examples for explaining that the magnitude of the power reduced by the peak power reducer 1212 differs according to the width of the occupied bandwidth. For example, even when there are three carrier signals multiplexed in the multi-carrier signal (N=3), it can still be said that the power reduced by the peak power reducer 1212 becomes larger as the occupied bandwidth of the multi-carrier signal becomes wider. In addition, for example, assuming that the respective carrier signals multiplexed in the multi-carrier signal have the same bandwidth and that the respective carrier signals are arranged at the same frequency spacing, the occupied bandwidth of the multi-carrier signal becomes wider as the number of carrier signals multiplexed in the multi-carrier signal increases. That is, under such an assumption, it can also be said that the power reduced by the peak power reducer 1212 becomes larger as the number (N) of the carrier signals increases, that is, as the occupied bandwidth of the multi-carrier signal becomes wider.

As mentioned earlier, the output power corrector 1215 suppresses the error between the power of a carrier signal to which the peak power reduction process has been applied by the peak power reducer 1212 and the prescribed reference output power for the corresponding carrier signal. Specifically, the output power corrector 1215 corrects the power of the carrier signal according to the power correction value reported from the control processor 110. However, the magnitude of the power reduced by the peak power reducer 1212 is different according to the width of the occupied bandwidth of the multi-carrier signal, and therefore, the value of the error regarded as the target of the correction, that is, the power correction value differs according to the width of the occupied bandwidth of the multi-carrier signal. Therefore, in order for the correction value generator 111 to report the power correction value according to the width of the occupied bandwidth of the multi-carrier signal to the first gain adjuster 1211, the power correction value for each occupied bandwidth of the multi-carrier signal is recorded in advance in the power correction value table 1111.

The correction value obtaining unit 1112 receives the first gain adjustment value for the processing-target carrier signal from the host device. In addition, the correction value obtaining unit 1112 receives information of the carrier frequency of each of the carrier signals multiplexed in the multi-carrier signal from the host device. The correction value obtaining unit 1112 calculates the occupied bandwidth of the multi-carrier signal by referring to the received information of the carrier frequencies and subtracting the lowest carrier frequency from the highest carrier frequency. In addition, the correction value obtaining unit 1112 obtains the power correction value according to the calculated occupied bandwidth from the power correction value table 1111. The correction value obtaining unit 1112 multiplies the first gain adjustment value by the power correction value. The correction value obtaining unit 1112 gives the first gain adjustment value multiplied by the power correction value to the first gain adjuster 1211 provided for the corresponding carrier signal.

The first gain adjuster 1211 receives the first gain adjustment value multiplied by the power correction value from the correction value obtaining unit 1112. The first gain adjuster 1211 adjusts the power of the baseband signal of the processing-target carrier in accordance with the prescribed reference output power for the carrier signal, according to the first gain adjustment value multiplied by the power correction value. That is, the first gain adjuster 1211 adjusts the power of the baseband signal of the processing-target carrier treated with a correction process by the output power corrector 1215.

Meanwhile, the correction value obtaining unit 1112 may also be configured so as to vive the power correction value and the first gain adjustment value separately to the first gain adjuster 1211. In this case, the first gain adjuster 1211 may be configured so as to reduce, according to the received first gain adjustment value, the power of the input baseband signal of a carrier in accordance with the prescribed reference output power for the carrier signal. The output power corrector 1215 may be configured to correct, according to the received power correction value, the output power of the baseband signal of the carrier that has been reduced according to the first gain adjustment value.

Through the processes performed by the correction value generator 111 and the output power corrector 1215 described above, the error between the transmission output power of a carrier signal to which the peak power reduction process has been applied and the reference output power for the carrier signal is suppressed in advance in accordance with the width of the occupied bandwidth of the multi-carrier signal. As a result, the accuracy of the transmission output power of each of the carrier signals multiplexed in the multi-carrier signal improves regardless of the width of the occupied bandwidth of the multi-carrier signal.

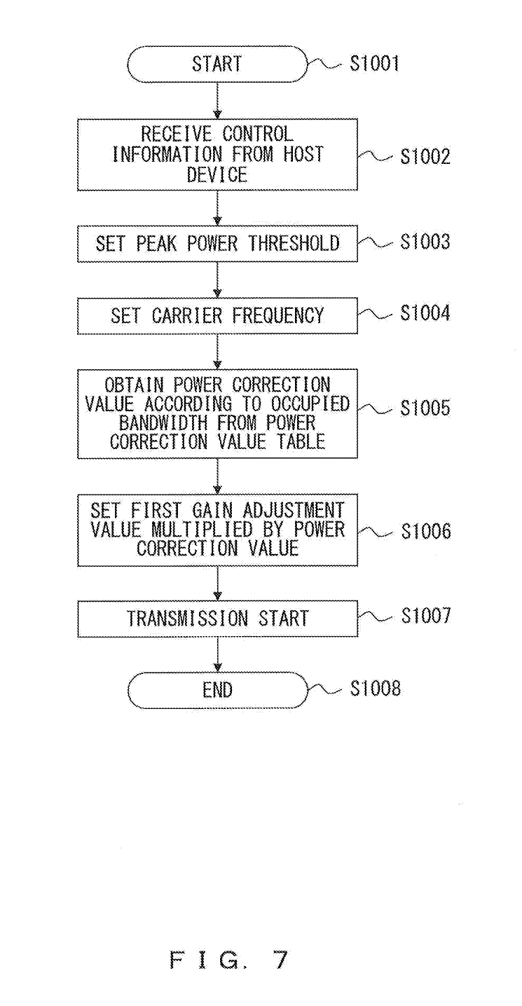

An example of the method for transmitting the multi-carrier signal executed by the radio device 100 is explained. FIG. 7 is an exemplary illustration of the process flow for the transmission of a multi-carrier signal executed by the radio device according to the first embodiment. In the example illustrated in FIG. 7, control values set by the control processor 110 are the first gain adjustment value multiplied by the power correction value, the peak power threshold, and the carrier frequency. Meanwhile, in FIG. 7, the respective processes in step S1003, step S1004, and step S1005 through step S1006 may be performed in parallel in terms of time.

When a series of processes for transmitting a multi-carrier signal start (step S1001), the control processor 110 receives control information from a host device (step S1002). Specifically, the correction value obtaining unit 1112 receives the first gain adjustment value for the processing-target carrier signal and information of the carrier frequency of each carrier signal. The threshold reporting unit 112 receives information of the radio access technology for the transmission-target multi-carrier signal from the host device. The frequency reporting unit 113 receives information of the carrier frequency of the processing-target carrier signal from the host device.

In step S1003, the threshold reporting unit 112 gives a prescribed peak power threshold according to the radio access technology to the peak reduction value calculator 130. The peak reduction value calculator 130 receives the peak power threshold from the threshold reporting unit 112. The peak reduction value calculator 130 sets the peak power threshold as the power threshold for the multi-carrier signal in which carrier signals generated by the respective transmission signal processors 121 are multiplexed.

In step S1004, the frequency reporting unit 113 gives the value of the carrier frequency to the modulators 1214, 1222 in the signal processor 120 provided for the corresponding carrier signal. The modulators 1214, 1222 receive the carrier frequency information of the processing-target carrier signal from the frequency reporting unit 113. The modulators 1214, 1222 sets the received carrier frequency information as the carrier frequency for modulating an input baseband signal.

In step S1005, the correction value obtaining unit 1112 calculates the occupied bandwidth of the multi-carrier signal by referring to the received information of the carrier frequencies and subtracting the lowest carrier frequency from the highest carrier frequency. The correction value obtaining unit 1112 obtains the power correction value according to the calculated occupied bandwidth from the power correction value table 1111. The correction value obtaining unit 1112 multiplies the first gain adjustment value by the obtained power correction value. The correction value obtaining unit 1112 gives the first gain adjustment value multiplied by the power correction value to the first gain adjuster 1211 provided for the corresponding carrier signal.

In step S1006, the first gain adjuster 1211 receives the first gain adjustment value multiplied by the power correction value from the correction value obtaining unit 1112. The first gain adjuster 1211 sets the first gain adjustment value multiplied by the power correction value as the gain adjustment value to be adjusted by this first gain adjuster 1211 that includes the output power corrector 1215.

In step S1007, the radio device 100 starts the transmission of a multi-carrier signal according to the set control values. Specifically, the first gain adjuster 1211 receives a baseband signals of carrier transmitted from application. Then, the respective transmission signal processors 121 generate carrier signals according to the set control values. The carrier signals generated by the respective transmission signal processors 121 are combined by the combiner 140 and a multi-carrier signal is generated. The multi-carrier signal generated by the combiner 140 is output via the antenna 190 after being subjected to the processes by the distortion compensator 150, the digital to analog converter 160, the radio frequency converter 170, and the power amplifier 180. The series of processes are terminated when the transmission of the multi-carrier signal ends (step S1008).

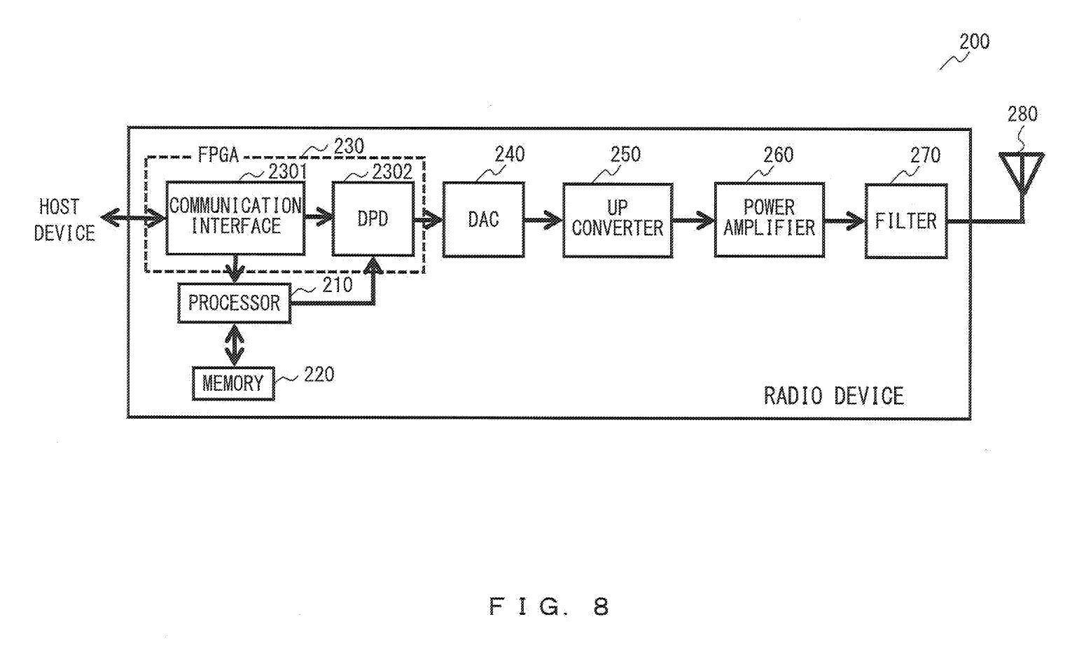

The radio device 100 is configured by hardware illustrated in FIG. 8, for example. FIG. 8 is an exemplary hardware configuration diagram of the radio device according to the first embodiment. As illustrated in FIG. 8, a radio device 200 includes a processor 210, a memory 220, a Field Programmable Gate Array (FPGA) 230, a DAC 240, an up converter 250, a power amplifier 260, a filter 270, and an antenna 280.

The processor 210 is a logic circuit such as a Central Processor (CPU) that performs operation processes. The processor 210 controls the operations of the respective circuit elements included in the radio device 200. The processor 210 corresponds to the control processor 110 and the peak reduction value calculator 130.

The memory 220 is a device in which a processing program executed by the processor 210, data used for the processing by the processor 210, and data of the processing result by the processor 210 are stored. The memory 220 includes the power correction value table 1111.

The FPGA 230 includes a communication interface 2301 and a Digital Pre-distortion (DPD) 2302.

The communication interface 2301 is an interface for transmitting and receiving a data signal of base band and control signals between the radio device 200 and a host device (not illustrated in the drawing) according to a prescribed communication standard. Examples of the communication standard include Common Public Radio Interface (CPRI) and Open Base Station Architecture Initiative (OBSAI), and the like. The communication interface 2301 forwards a data signal received from the host device to the DPD 2302, and forwards a control signal received from the host device to the processor 210, for example.

The DPD 2302 receives the data signal of base band transmitted from the host device via the communication interface 2301. The DPD 2302 applies digital processing to the received data signal according to control signals received from the processor 210. The DPD 2302 corresponds to the signal processors 120-1 through 120-N, the peak reduction value calculator 130, the combiner 140, and the distortion compensator 150.

The DAC 240 converts the data signal processed by the DPD 2302 from digital to analog. The DAC 240 corresponds to the digital to analog converter 160. The up converter 250 up-converts the analog-converted data signal to radio frequency. The up converter 250 corresponds to the radio frequency converter 170.

The power amplifier 260 amplifies the transmission output power of the data signal of radio frequency to a prescribed reference output power. The power amplifier 260 corresponds to the power amplifier 180. The filter 270 is a splitter that separates the data signal transmitted via the antenna 280 and the data signal received via the antenna 280. The antenna 280 emits the data signal received via the filter 270 to a radio terminal device (not illustrated in the drawing) that communicates with the radio device 200, and the antenna 280 guides the data signal received from a radio terminal device to the filter 270. The antenna 280 corresponds to the antenna 190.

Thus, the following effects may be obtained with the radio device according to the first embodiment. That is, the error between the transmission output power of a carrier signal to which a peak power reduction process has been applied and a prescribed reference power of the carrier signal is suppressed in accordance with the width of the occupied bandwidth of the multi-carrier signal in the process of the generation of each of the carrier signals multiplexed in the multi-carrier signal. As a result, with the radio device according to the first embodiment, the accuracy of the transmission output power of each of carrier signals multiplexed in a multi-carrier signal improves regardless of the width of the occupied bandwidth of the multi-carrier signal.

### Second Embodiment

In the first embodiment, the output power corrector 1215 is included in the first gain adjuster 1211. For this reason, the error between the transmission output power of a carrier signal to which a peak power reduction process is applied and the reference output power for the carrier signal is suppressed before the peak power reduction process is applied to the carrier signal. However, the radio device may be configured so as to suppress such an error after the peak power reduction process is applied to the carrier signal.

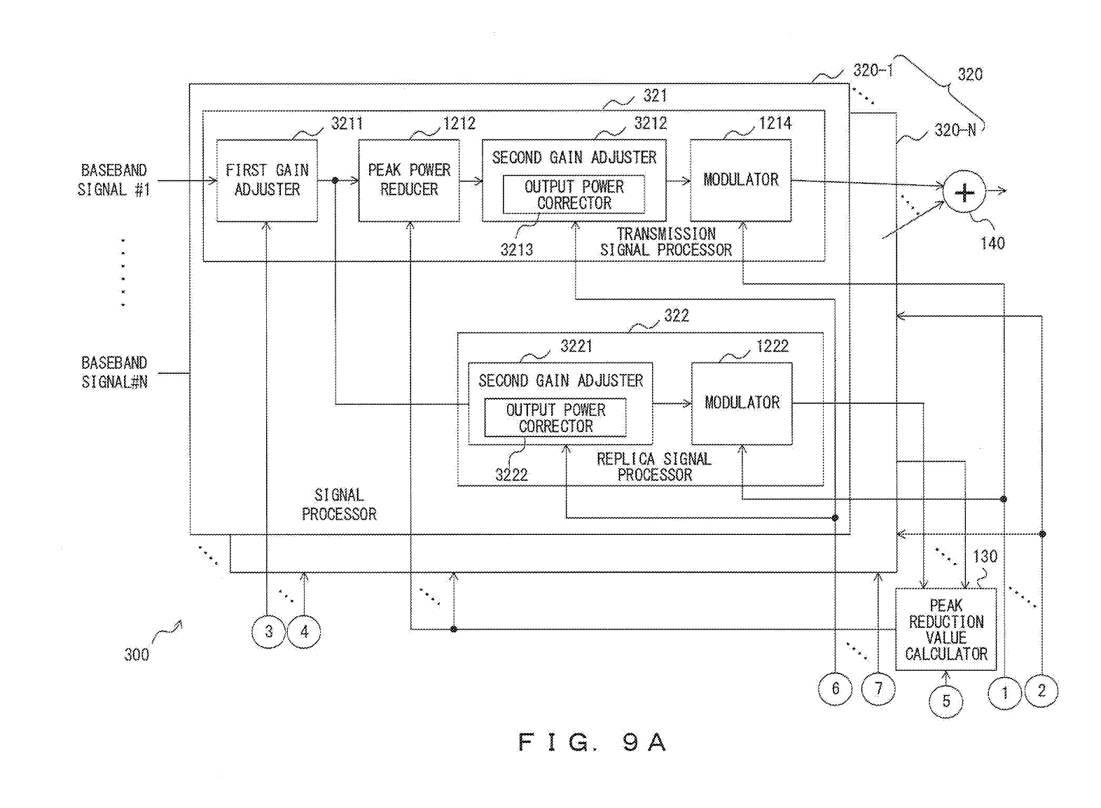

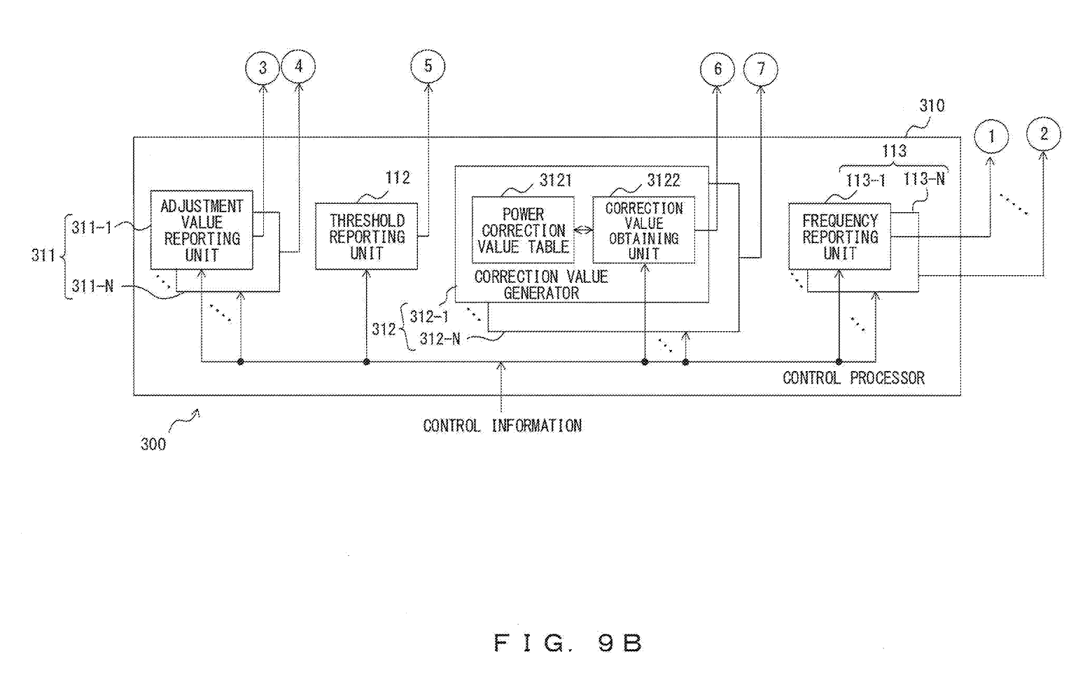

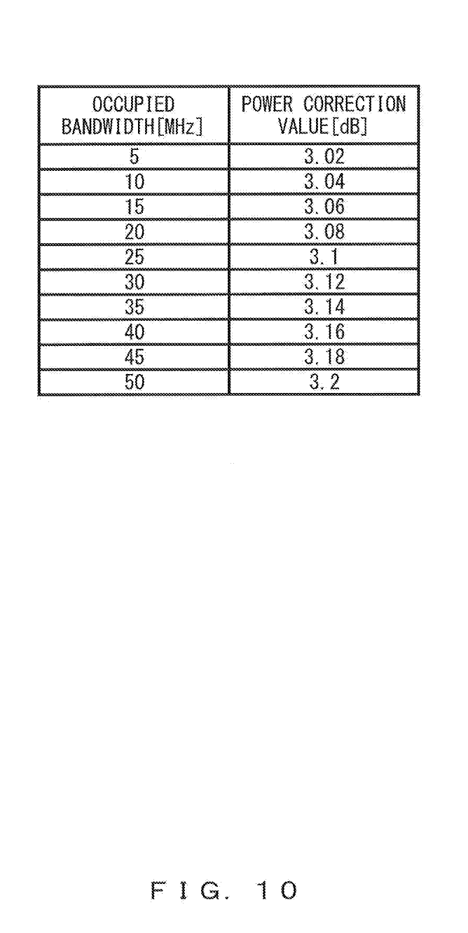

FIGS. 9A-9B are exemplary function configuration diagrams of a radio device according to the second embodiment. In FIG. 9, in the circuit elements of a radio device 300 according to the second embodiment, the same circuit elements as those in the radio device 100 (see FIGS. 1A-1C) are indicated by the same reference numerals as the reference numerals of the circuit elements of the radio device 100. The radio device 300 is configured by hardware illustrated in FIG. 8, for example. Note that the distortion compensator 150, the DAC 160, the radio frequency converter 170, the power amplifier 180, and the antenna 190 are substantially the same in the first and second embodiments, and thus they are omitted in FIGS. 9A-9B.

As illustrated in FIGS. 9A-9B, the radio device 300 includes a control processor 310 instead of the control processor 110 (see FIG. 1C). In addition, the radio device 300 includes signal processors 320 instead of the signal processors 120 (see FIG. 1B).

The signal processors 320-1 through 320-N respectively include a transmission signal processor 321 instead of the transmission signal processor 121 (see FIG. 1B). In addition, the signal processors 320-1 through 320-N respectively include a replica signal processor 322 instead of the replica signal processor 122 (see FIG. 1B).

The transmission signal processor 321 includes a first gain adjuster 3211 instead of the first gain adjuster 1211 (see FIG. 1B). The transmission signal processor 321 includes a second gain adjuster 3212 instead of the second gain adjuster 1213 (see FIG. 1B). The transmission signal processor 321 includes an output power corrector 3213 instead of the output power corrector 1215 (see FIG. 1B). The output power corrector 3213 may be included in the second gain adjuster 3212.

The first gain adjuster 3211 adjusts the gain of carrier signals multiplexed into the multi-carrier signal so that the transmission output power of the multi-carrier signal transmitted from the antenna 190 via the power amplifier 180 becomes a prescribed reference output power. Specifically, the first gain adjuster 3211 reduces the power of the input baseband signal of a carrier to a prescribed reference output power for the corresponding carrier signal according to a first gain adjustment value reported from the control processor 310.

Thus, the first gain adjuster 3211 has a similar function as that of the first gain adjuster 1211. However, unlike the first gain adjuster 1211, the first gain adjuster 3211 does not include the output power corrector 1215 (see FIG. 1B).

The second gain adjuster 3212 adjusts the gain of carrier signals multiplexed in the multi-carrier signal so that the multi-carrier signal before conversion to radio frequency is converted from digital to analog at the optimal operation point of the digital to analog converter 160. Specifically, the second gain adjuster 3212 increases the power of an input baseband signal according to a second gain adjustment value reported from the control processor 310.

Thus, the second gain adjuster 3212 has a similar function as that of the second gain adjuster 1213. However, the second gain adjustment value is reported from the control processor 310 to the second gain adjuster 3212, while the second gain adjustment value is set in advance in the second gain adjuster 1213. In addition, unlike the second gain adjuster 1213, the second gain adjuster 3212 includes the output power corrector 3213.

The output power corrector 3213 corrects the error between the power of a carrier signal to which a peak power reduction process has been applied by the peak power reducer 1212 and the prescribed reference output power for the corresponding carrier signal. Specifically, the output power corrector 3213 corrects the power of an input baseband signal according to a power correction value reported from the control processor 310.

Thus, the output power corrector 3213 has a similar function as that of the output power corrector 1215. However, the output power corrector 3213 differs from the output power corrector 1215 included in the first gain adjuster 1211, in that the output power corrector 3213 is included in the second gain adjuster 3212.

The power correction value may be multiplied by the second gain adjustment value so as to be reported from the control processor 310 to the second gain adjuster 3212 together with the second gain adjustment value. In this case, the second gain adjuster 3212 including the output power corrector 3213 may be configured so as to adjust the power of an input baseband signal according to second gain adjustment value multiplied by the power correction value.

The replica signal processor 322 generate a carrier signal to which the process by the peak power reducer 1212 is not applied. The replica signal processor 322 includes a second gain adjuster 3221 instead of the second gain adjuster 1221 (see FIG. 1B). The second gain adjuster 3221 has substantially the same function as that of the second gain adjuster 3212 included in the transmission signal processor 321. The output power corrector 3222 has substantially the same function as that of the output power corrector 3222 included in the transmission signal processor 321.

In the example illustrated in FIG. 9A, the peak reduction value calculator 130 calculates the peak reduction value using a replica of a multi-carrier signal treated with a correction according to the power correction value. That is, in the example illustrated in FIG. 9A, the replica of a carrier signal treated with the power correction by the output power corrector 3222 is generated by each replica signal processor 322, and the generated replica signal of each carrier is input to the peak reduction value calculator 130. However, the peak reduction value calculator 130 may be configured so as to calculate the peak reduction value using a replica of a multi-carrier signal that is not treated with the correction according to the power correction value. In this case, each replica signal processor 322 may be configured so as to generate a replica of a carrier signal that is not treated with the correction according to the power correction value. Specifically, each replica signal processor 322 may be configured so as not to include the output power corrector 3222 in the second gain adjuster 3221.

The control processor 310 includes adjustment value reporting units 311-1 through 311-N instead of the correction value generators 111-1 through 111-N (see FIG. 1C). In addition, the control processor 310 includes correction value generators 312-1 through 312-N.

The adjustment value reporting unit 311 receives the first gain adjustment value for the processing-target carrier signal from the host device. The adjustment value reporting unit 311 gives the first gain adjustment value to the first gain adjuster 3211 provided for the corresponding carrier signal. Thus, the adjustment value reporting unit 311 has a similar function as a part of the function of the correction value generator 111 (see FIG. 1C). However, the adjustment value reporting unit 311 differs from the correction value generator 111 in that the adjustment value reporting unit 311 does not generate and transmit the power correction value.

The correction value generator 312 holds in advance the second gain correction value for the processing-target carrier signal. In addition, the correction value generator 312 receives information of the carrier frequency of each of the carrier signals multiplexed in the multi-carrier signal from the host device. The correction value generator 312 generates the power correction value for the processing-target carrier signal using the received information of each carrier frequency. The correction value generator 312 multiplies the held second gain adjustment value by the generated power correction value. The correction value generator 312 gives the second gain adjustment value multiplied by the power correction value to the second gain adjusters 3212, 3221 in the signal processor 320 provided for the corresponding carrier signal.

Thus, the correction value generator 312 has a similar function as that of the correction value generator 111 in generating the power correction value using information of each carrier frequency received from a host device. However, the correction value generator 312 differs from the correction value generator 111 that receives the first gain adjustment value from a host device, in that the correction value generator 312 holds in advance the second gain adjustment value. In addition, the correction value generator 312 differs from the correction value generator 111 that gives the first gain adjustment value multiplied by the power correction value to the first gain adjuster 1211, in that the correction value generator 312 gives the second gain adjustment value multiplied by the power correction value to the second gain adjusters 3212, 3221.

The correction value generators 312-1 through 312-N respectively include a power correction value table 3121 and a correction value obtaining unit 3122.

In the power correction value table 3121, the power correction value is recorded for each occupied bandwidth of the multi-carrier signal. The power correction value table 3121 may be a table similar to the power correction value table 1111 illustrated in FIG. 3.

The correction value obtaining unit 3122 receives information of the carrier frequency of each of the carrier signals multiplexed in the multi-carrier signal from the host device. The correction value obtaining unit 3122 calculates the occupied bandwidth of the multi-carrier signal by referring to the received information of the carrier frequencies and subtracting the lowest carrier frequency from the highest carrier frequency. The correction value obtaining unit 3122 obtains the power correction value according to the calculated occupied bandwidth from the power correction value table 3121. The correction value obtaining unit 3122 multiplies the second gain adjustment value held in advance by the obtained power correction value. The correction value obtaining unit 3122 gives the second gain adjustment value multiplied by the power correction value to the second gain adjusters 3212, 3221 in the signal processor 320 provided for the corresponding carrier signal.

The second gain adjuster 3212 receives the second gain adjustment value multiplied by the power correction value from the correction value obtaining unit 3122. The second gain adjuster 3212 adjusts the output power of the processing-target carrier signal so that digital to analog converter 160 operates at the optimal operation point, according to the second gain adjustment value multiplied by the power correction value. That is, the second gain adjuster 3212 adjusts the power of the baseband signal of the processing-target carrier treated with the correction process by the output power corrector 3213. The second gain adjuster 3221 operates in a manner similar to that of the second gain adjuster 3212.

Meanwhile, the correction value obtaining unit 3122 may also be configured so as to give the power correction value and the second gain adjustment value separately to the second gain adjuster 3212, 3221 provided for the corresponding carrier signal. In this case, the second gain adjuster 3212 may be configured so as to reduce, according to the received second gain adjustment value, the power of an input baseband signal of a carrier in accordance with a prescribed reference output power. The output power corrector 3213 included in the second gain adjuster 3212 may also be configured so as to correct, according to the received power adjustment value, the output power of the baseband signal of the carrier reduced in accordance with the second gain adjustment value. The second gain adjuster 3221 and the output power corrector 3222 may be configured so as to operate in a manner similar to that of the second gain adjuster 3212 and the output power corrector 3213.

Through the processes performed by the correction value generator 312 and the output power corrector 3213 described above, the error between the transmission output power of the carrier signal to which a peak power reduction process is applied and the reference output power for the carrier signal is suppressed in accordance with the width of the occupied bandwidth of the multi-carrier signal. As a result, the accuracy of the transmission output power of each of carrier signals multiplexed in a multi-carrier signal improves regardless of the width of the occupied bandwidth of the multi-carrier signal.

Meanwhile, the correction value generator 312 may further be configured as explained below.

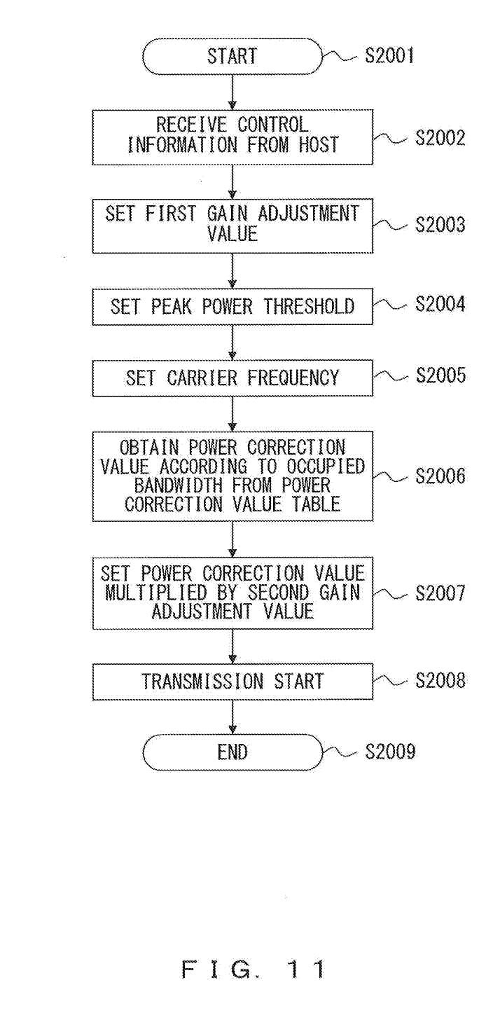

Instead of holding the second gain adjustment value in the correction value obtaining unit 3122 in advance, the power correction value multiplied by the second gain adjustment value is recorded for each occupied bandwidth of the multi-carrier signal in the power correction value table 3121, as illustrated in FIG. 10. FIG. 10 is an example of the power correction value table according to the second embodiment.

The correction value obtaining unit 3122 receives information of the carrier frequency of each of the carrier signals multiplexed in the multi-carrier signal from the host device. The correction value obtaining unit 3122 calculates the occupied bandwidth of the multi-carrier signal by referring to the received information of the carrier frequencies and subtracting the lowest carrier frequency from the highest carrier frequency. The correction value obtaining unit 3122 obtains the power correction value according to the calculated occupied bandwidth from the power correction value table 3121. The obtained power correction value has been multiplied by the second gain adjustment value in advance. The correction value obtaining unit 3122 gives the obtained power correction value to the second gain adjusters 3212, 3221 in the signal processor 320 provided for the corresponding carrier signal.

The second gain adjuster 3212 receives the power correction value multiplied by the second gain adjustment value from the correction value obtaining unit 3122. The second gain adjuster 3212 adjusts the power of an input carrier signal so that the digital to analog converter 160 operates at the optimal operation point, according to the power correction value multiplied by the second gain adjustment. That is, the second gain adjuster 3212 adjusts the power of the baseband signal of the processing-target carrier treated with the correction process by the output power corrector 3213. The second gain adjuster 3221 operates in a manner similar to that of the second gain adjuster 3212.

According to a configuration such as the one described above, the error between the transmission output power of a carrier signal to which a peak power reduction process is applied and the reference output power for the carrier signal is also suppressed in accordance with the width of the occupied bandwidth of the multi-carrier signal. As a result, the accuracy of the transmission output power of each of carrier signals multiplexed in a multi-carrier signal improves regardless of the width of the occupied bandwidth of the multi-carrier signal.

In addition, according to a configuration such as the one described above, the process for multiplying the second gain adjustment value by the power correction value in the correction value generator 312 is not required, and therefore, it becomes possible to simplify and speed up the processing in the control processor 310 that includes the correction value generator 312.

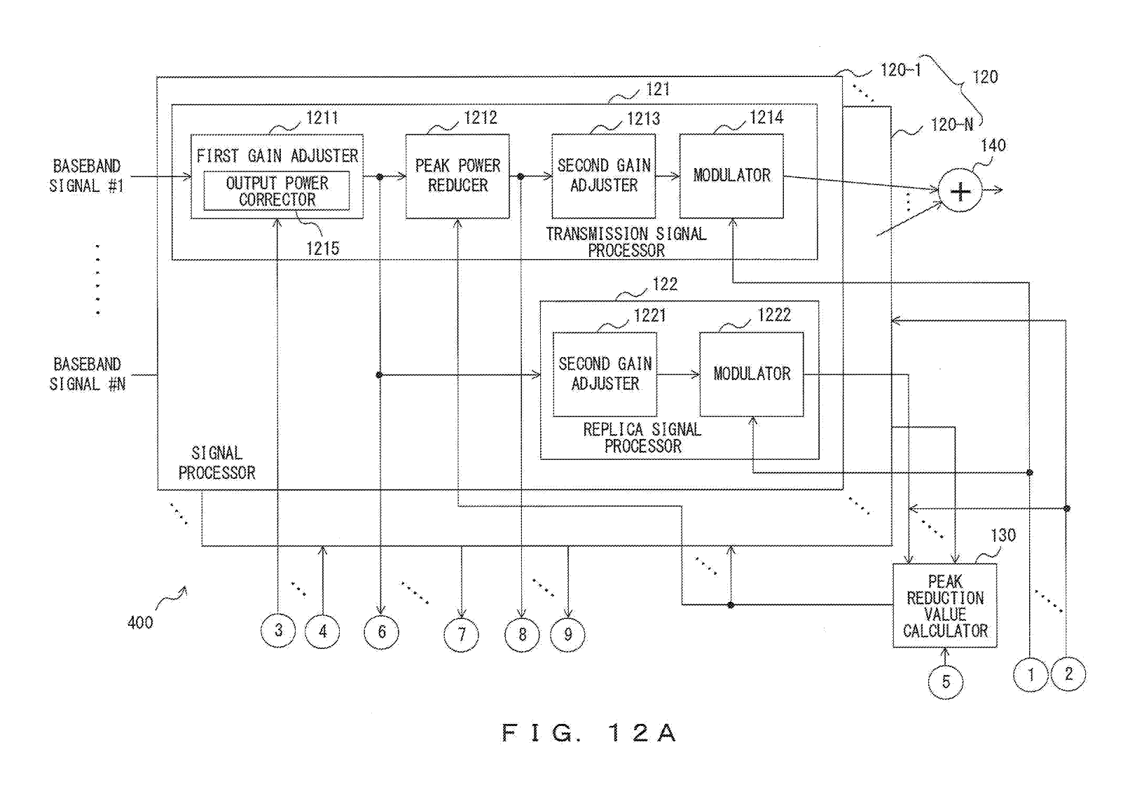

An example of the method for transmitting the multi-carrier signal executed by the radio device 300 is explained. FIG. 11 is an exemplary illustration of the process flow for the transmission of a multi-carrier signal executed by the radio device according to the second embodiment. In the example illustrated in FIG. 11, control values set by the control processor 310 are the first gain adjustment value, the peak power threshold, the carrier frequency, and the power correction value multiplied by the second gain adjustment value. Meanwhile, in FIG. 11, the respective processes in step S2003, step S2004, step S2005, and step S2006 through step S2007 may be performed in parallel in terms of time.

When a series of processes for transmitting a multi-carrier signal start (step S2001), the control processor 310 receives control information from a host device (step S2002). Specifically, the adjustment value reporting unit 311 receives the first gain adjustment value for the processing-target carrier signal from the host device. The threshold reporting unit 112 receives information of the radio access technology for the transmission-target multi-carrier signal from the host device. The correction value obtaining unit 3122 receives information of the carrier frequency of each carrier signal from the host device. The frequency reporting unit 113 receives information of the carrier frequency of the processing-target carrier signal from the host device.

In step S2003, the adjustment value reporting unit 311 gives the first gain adjustment value to the first gain adjuster 3211 provided for the corresponding carrier signal. The first gain adjuster 3211 receives the first gain adjustment value for the processing-target carrier signal from the adjustment value reporting unit 311. The first gain adjuster 3211 sets the received first gain adjustment value as the value for adjusting the power of an input baseband signal of a carrier to the prescribed reference output power for the carrier signal.

In step S2004, the threshold reporting unit 112 gives a prescribed peak power threshold according to the radio access technology to the peak reduction value calculator 130. The peak reduction value calculator 130 receives the peak power threshold from the threshold reporting unit 112. The peak reduction value calculator 130 sets the peak power threshold as the power threshold for the multi-carrier signal in which carrier signals generated by the respective transmission signal processors 321 are multiplexed.

In step S2005, the frequency reporting unit 113 gives the value of the carrier frequency to the modulators 1214, 1222 in the signal processor 320 provided for the corresponding carrier signal. The modulators 1214, 1222 receive the carrier frequency information of the processing-target carrier signal from the frequency reporting unit 113. The modulators 1214, 1222 set the received carrier frequency information as the carrier frequency for modulating an input baseband signal.

In step S2006, the correction value obtaining unit 3122 calculates the occupied bandwidth of the multi-carrier signal by referring to the received information of the carrier frequencies and subtracting the lowest carrier frequency from the highest carrier frequency. The correction value obtaining unit 3122 obtains the power correction value according to the occupied bandwidth from the power correction value table 3121. The obtained power correction value has been multiplied by the second gain adjustment value in advance. That is, a fixed value is used as the second gain adjustment value without depending on the occupied bandwidth of the multi-carrier signal, and therefore, the value obtained by multiplying the power correction value according to the occupied bandwidth by the second gain adjustment value may be stored in advance in the power correction value table 3121. The correction value obtaining unit 3122 gives the obtained power correction value to the second gain adjusters 3212, 3221 in the signal processor 320 provided for the corresponding carrier signal.

In step S2007, the second gain adjuster 3212 receives the power correction value multiplied by the second gain adjustment value from the correction value obtaining unit 3122. The second gain adjuster 3212 sets the power correction value multiplied by the second gain adjustment value as the gain adjustment value to be adjusted by this second gain adjuster 3212 that includes the output power corrector 3213. The second gain adjuster 3221 performs processes similar to these processes performed by the second gain adjuster 3212.

In step S2008, the radio device 300 starts the transmission of a multi-carrier signal according to the set control values. Specifically, the first gain adjuster 3211 receives baseband signals of carriers generated by the application. The respective transmission signal processors 321 generate carrier signals according to the set control values. The carrier signals generated by the respective transmission signal processors 321 are combined by the combiner 140, and a multi-carrier signal is generated. The multi-carrier signal generated by the combiner 140 is transmitted via the antenna 190 after being subjected to the processes by the distortion compensator 150, the digital to analog converter 160, the radio frequency converter 170, and the power amplifier 180. The series of processes are terminated when the transmission of the multi-carrier signal ends (step S2009).

As described above, with the radio device 300 according to the second embodiment, an effect that is similar to the effect obtained with the radio device 100 according to the first embodiment may also be obtained. In addition, with the radio device 300 according to the second embodiment, it becomes possible to simplify and speed up the process for correcting error between the transmission output power of a carrier signal to which a peak power reduction process has been applied and the reference output power for the carrier signal.

### Third Embodiment

In the first embodiment, the radio device suppresses the error between the transmission output power of a carrier signal to which a peak power reduction process has been applied and the reference output power for the carrier signal before the peak power reduction process is applied to the carrier signal. In addition, in the first embodiment, the radio device holds in advance the power correction value for each occupied bandwidth of the multi-carrier signal in order to correct such an error. However, the radio device may also be configured so as to generate the power correction value for the carrier signals multiplexed in the transmission-target multi-carrier signal while these carrier signals are being generated.

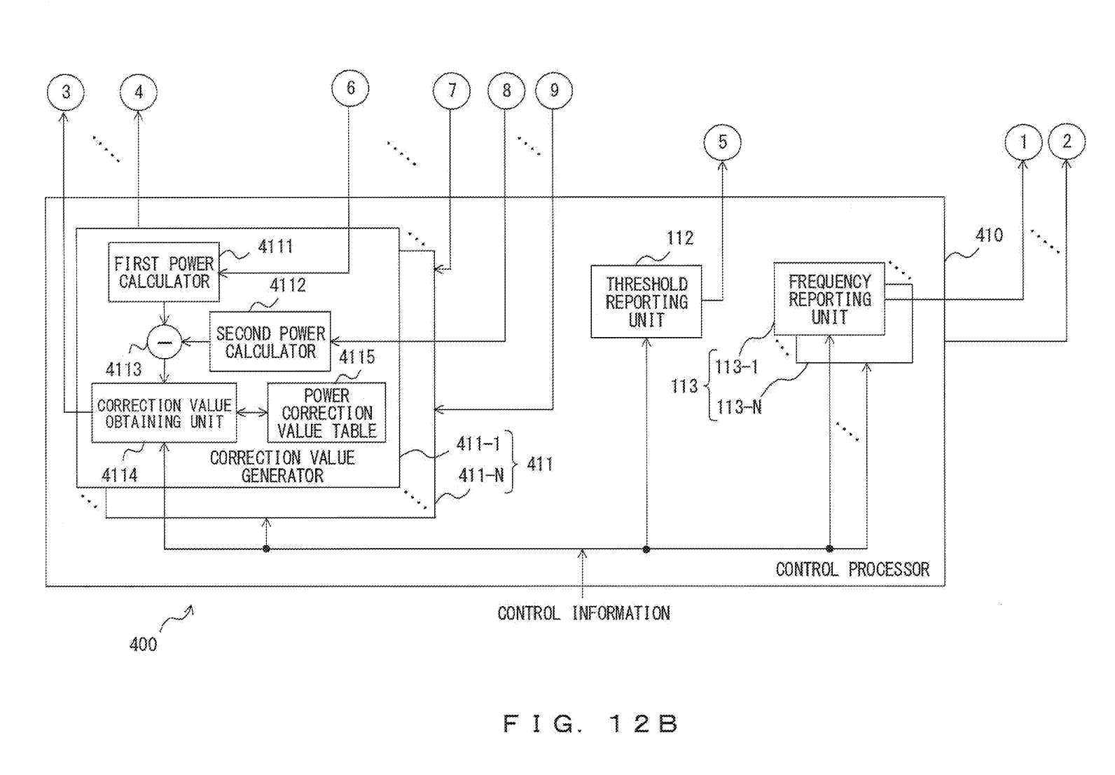

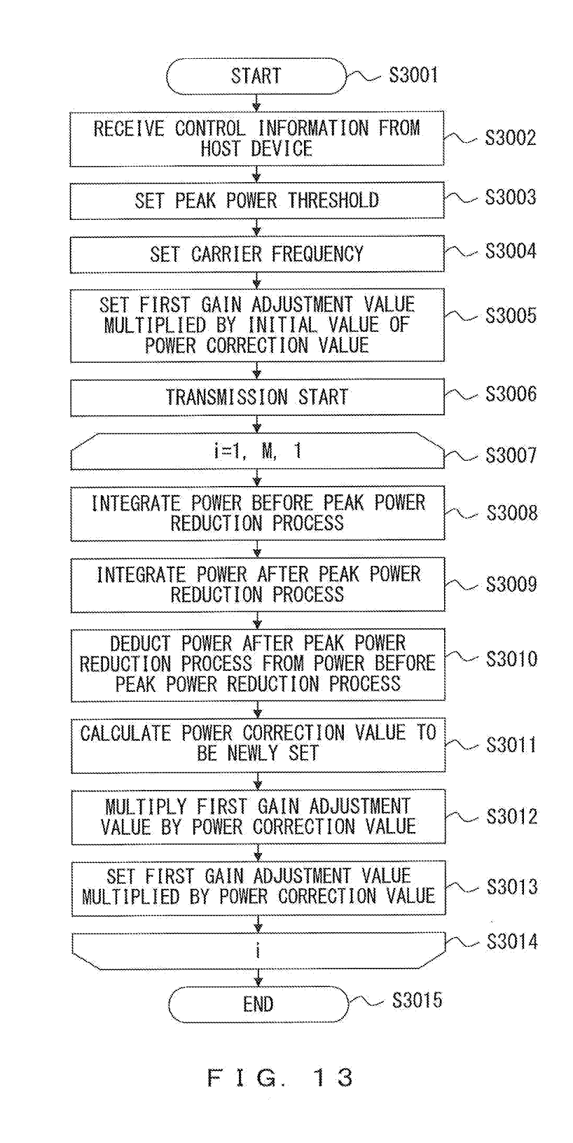

FIGS. 12A-12B are exemplary function configuration diagrams of a radio device according to the third embodiment. In FIGS. 12A-12B, in the constituent elements of a radio device 400 according to the third embodiment, the same circuit elements as those in the radio device 100 (see FIGS. 1A-1C) are indicated by the same reference numerals as the reference numerals of the circuit elements of the radio device 100. The radio device 400 is configured by hardware illustrated in FIG. 8, for example. Note that the distortion compensator 150, the DAC 160, the radio frequency converter 170, the power amplifier 180, and the antenna 190 are substantially the same in the first and third embodiments, and thus they are omitted in FIGS. 12A-12B.

As illustrated in FIGS. 12A-12B, a radio device 400 includes a control processor 410 instead of the control processor 110 (see FIG. 1C). The control processor 410 includes correction value generators 411-1 through 411-N instead of the correction value generators 111-1 through 111-N (see FIG. 1C).

The correction value generator 411 stores initial values of the power correction values for processing-target carrier signals, for each occupied bandwidth of the multi-carrier signal. For example, the correction value generator 411 stores a power correction value table such as the one illustrated in FIG. 3.

The correction value generator 411 receives the first gain adjustment value for the processing-target carrier signal from a host device. In addition, the correction value generator 411 receives information of the carrier frequency of each of the carrier signals multiplexed in the multi-carrier signal. The correction value generator 411 calculates the occupied bandwidth of the multi-carrier signal using the received information of each carrier frequency. The correction value generator 411 selects the initial value of the power correction value according to the calculated occupied bandwidth from the initial values of the power correction values stored in advance. The correction value generator 411 holds the initial value of the power correction value as the power correction value to be used by the output power corrector 1215 provided for the corresponding carrier signal. The correction value generator 411 multiplies the received first gain adjustment value by the held power correction value. The correction value generator 411 gives the first gain adjustment value multiplied by the power correction value to the first gain adjuster 1211 provided for the corresponding carrier signal.

Meanwhile, after the transmission of the multi-carrier signal starts, the correction value generator 411 generates the power correction value from the processing-target carrier signal. Specifically, the correction value generator 411 calculates a first power and a second power. The first power is the power of the carrier signal before the peak power reduction process is applied to it, that is, specifically, the power of the baseband signal of the carrier that is input to the peak power reducer 1212. The second power is the power of the carrier signal after the peak power reduction process is applied to it, that is, specifically, the power of the baseband signal of the carrier that is output from the peak power reducer 1212. The correction value generator 411 calculates a new power correction value using the difference between the first power and the second power.

In a manner similar to that in the first embodiment, the peak power reducer 1212 reduces the power of the multi-carrier signal in which the respective carrier signals are multiplexed so as to make it equal to or smaller than a prescribed peak power threshold set by the control processor 410, by multiplying the base band of the input carrier by a peak reduction value. The peak reduction value is calculated by the peak reduction value calculator 130 by comparing a replica of the multi-carrier signal generated through the process performed by the replica signal processor 122 with a peak power threshold reported from the control processor 110. The replica of the multi-carrier signal used for the calculation of the peak reduction value has the same occupied bandwidth as that of the multi-carrier signal. For this reason, it can be said that the peak reduction value is a value calculated according to the occupied bandwidth of the multi-carrier signal, and therefore, it can be said that the second power that is output from the peak power reducer 1212 using the peak reduction value is also a power to which a reduction process has been applied according to the occupied bandwidth of the multi-carrier signal. Therefore, it can be said that the power correction value generated from the difference value between the first power and the second power is a value generated according to the occupied bandwidth of the multi-carrier signal. In other words, it can be said that the power correction value generated from the difference value between the first power and the second power depends on the occupied bandwidth of the multi-carrier signal.

The correction value generator 411 generates a power correction value that is newly used by the output power corrector 1215 provided for the corresponding carrier signal, from the difference value between the first power and the second power and the power correction value that has been already held by the correction value generator 411. For example, the correction value generator 411 calculates the weighted average of the difference value between the first power and the second power and the power correction value that has been already held by the correction value generator 411. The correction value generator 411 holds the newly generated power correction value. The correction value generator 411 multiplies the received first gain adjustment value by the held power correction value. The correction value generator 411 gives the first gain adjustment value multiplied by the power correction value to the first gain adjuster 1211 provided for the corresponding carrier signal.

Meanwhile, the generation process for the power correction value after the start of the transmission of the multi-carrier signal may be repeated a prescribed number of times at a prescribed time interval. With the repeated execution of the generation process for the power correction value, it becomes possible to improve the accuracy in suppressing the error between the transmission output power of a carrier signal to which a peak power reduction process has been applied and the reference output power for the carrier signal.

As described above, the correction value generator 411 has a similar function to that of the correction value generator 111 (see FIG. 1C) in generating a power correction value and giving the generated the first gain adjustment value multiplied by the generated the power correction value to the first gain adjuster 1211. However, the correction value generator 411 differs from the correction value generator 111 in that, after the start of the transmission of the multi-carrier signal, the correction value generator 411 generates the power correction value using the power of the carrier signal before the peak power reduction process and the power of the carrier signal after the peak power reduction process.

The correction value generators 411-1 through 411-N respectively include a first power calculator 4111, a second power calculator 4112, a difference detector 4113, a correction value obtaining unit 4114, and a power correction value table 4115.

The correction value obtaining unit 4114 receives the first gain adjustment value for the processing-target carrier signal from the host device. In addition, the correction value obtaining unit 4114 receives information of the carrier frequency of each of the carrier signals multiplexed in the multi-carrier signal from the host device. The correction value obtaining unit 4114 calculates the occupied bandwidth of the multi-carrier signal by referring to the received information of the carrier frequencies and subtracting the lowest carrier frequency from the highest carrier frequency. The correction value obtaining unit 4114 obtains the power correction value according to the calculated occupied bandwidth from the power correction value table 4115. The power correction value table 4115 is a table such as the one illustrated in FIG. 3 for example. The correction value obtaining unit 4114 holds the obtained power correction value. The correction value obtaining unit 4114 multiplies the received first gain adjustment value by the held power correction value. The correction value obtaining unit 4114 gives the first gain adjustment value multiplied by the power correction value to the first gain adjuster 1211 provided for the corresponding carrier signal.

After the start of the transmission of the multi-carrier signal, the first power calculator 4111 calculates the first power of the processing-target carrier signal from the baseband signal of the carrier that is input to the peak power reducer 1212 provided for the corresponding carrier signal. The second power calculator 4112 calculates the second power of the processing-target carrier signal from the baseband signal of the carrier that is output from the peak power reducer 1212 provided for the corresponding carrier signal. The difference detector 4113 detects the difference between the first power calculated by the first power calculator 4111 and the second power calculated by the second power calculator 4112. The correction value obtaining unit 4114 obtains the power difference value detected by the difference detector 4113. The correction value obtaining unit 4114 calculates the weighted average of the obtained power difference value and the power correction value that has already been held. The correction value obtaining unit 4114 holds the calculated value as a new power correction value. The correction value obtaining unit 4114 multiplies the first gain adjustment value received from the host device by the held power correction value. The correction value obtaining unit 4114 gives the first gain adjustment value multiplied by the power correction value to the first gain adjuster 1211 provided for the corresponding carrier signal.

As described above, the correction value generator 411 generates the power correction value using the baseband signal of the carrier that is actually processed by the signal processors 120, and therefore, the power correction value is generated with a good accuracy.

The first gain adjuster 1211 receives the first gain adjustment value multiplied by the power correction value from the correction value obtaining unit 4114. The first gain adjuster 1211 adjusts the power of an input carrier signal in accordance with the prescribed reference output power for the carrier signal, according to the first gain adjustment value multiplied by the power correction value. That is, the first gain adjuster 1211 adjusts the power of the baseband signal of the processing-target carrier treated with a correction process by the output power corrector 1215.

Meanwhile, the correction value obtaining unit 4114 may also be configured so as to give the power correction value and the first gain adjustment value separately to the first gain adjuster 1211. In this case, the first gain adjuster 1211 may also be configured so as to reduce, according to the received first gain adjustment value, the power of an input baseband signal of a carrier in accordance with the prescribed reference output power for the carrier signal. The output power corrector 1215 included in the first gain adjuster 1211 may also be configured to correct, according to the received power correction value, the output power of the baseband signal of the carrier reduced in accordance with the first gain adjustment value.

Through the processes performed by the correction value generator 411 and the output power corrector 1215 described above, the error between the transmission output power of a carrier signal to which a peak power reduction process has been applied and the reference output power for the carrier signal is suppressed in accordance with the width of the occupied bandwidth of the multi-carrier signal. As a result, the accuracy of the transmission output power of each of carrier signals multiplexed in a multi-carrier signal improves regardless of the width of the occupied bandwidth of the multi-carrier signal.

Meanwhile, described above is merely a configuration example of the radio device according to the third embodiment, and for example, the radio device according to the third embodiment may also be configured so as to execute the processes described below. That is, the control processor 410 associates and stores the power correction values generated by the correction value generator 411 with the occupied bandwidths of the multi-carrier signal to be transmitted. The control processor 410 calculates a new bandwidth of a multi-carrier signal using information of carrier frequencies newly reported from a host device. The control processor 410 decides whether or not the power correction value according to the calculated occupied bandwidth has already been stored. When it is decided that the power correction value according to the calculated occupied bandwidth has already been stored, the control processor 410 reports the power correction value according to the calculated occupied bandwidth to the first gain adjuster 1211. When it is decided that the power correction value according to the calculated occupied bandwidth has not been stored, the control processor 410 generates the power correction value according to the calculated occupied bandwidth through the process performed by the correction value generator 411, and reports the newly generated power correction value to the first gain adjuster 1211. According to such a configuration, the radio device 400 does not need to generate a power correction value every time information of the carrier frequency is newly reported from the host device. As a result, according to the configuration described above, it becomes possible to speed up and simplify the process for suppressing the error between the transmission output power of a carrier signal to which a peak power reduction process is applied and the reference output power for the carrier signal.

Meanwhile, in the description above, the correction value obtaining unit 4114 obtains the power correction value from the power correction value table 4115 at the time of the start of transmission. However, the radio device 400 may be configured so as not to include the power correction value table 4115, and the correction value obtaining unit 4114 may be configured so as to hold a default value as the power correction value at the time of the start of transmission. According to such a configuration, during the transmission of the multi-carrier signal, the error between the transmission output power of a carrier signal to which a peak power reduction process has been applied and the reference output power for the carrier signal is also suppressed in accordance with the occupied bandwidth of the multi-carrier signal.

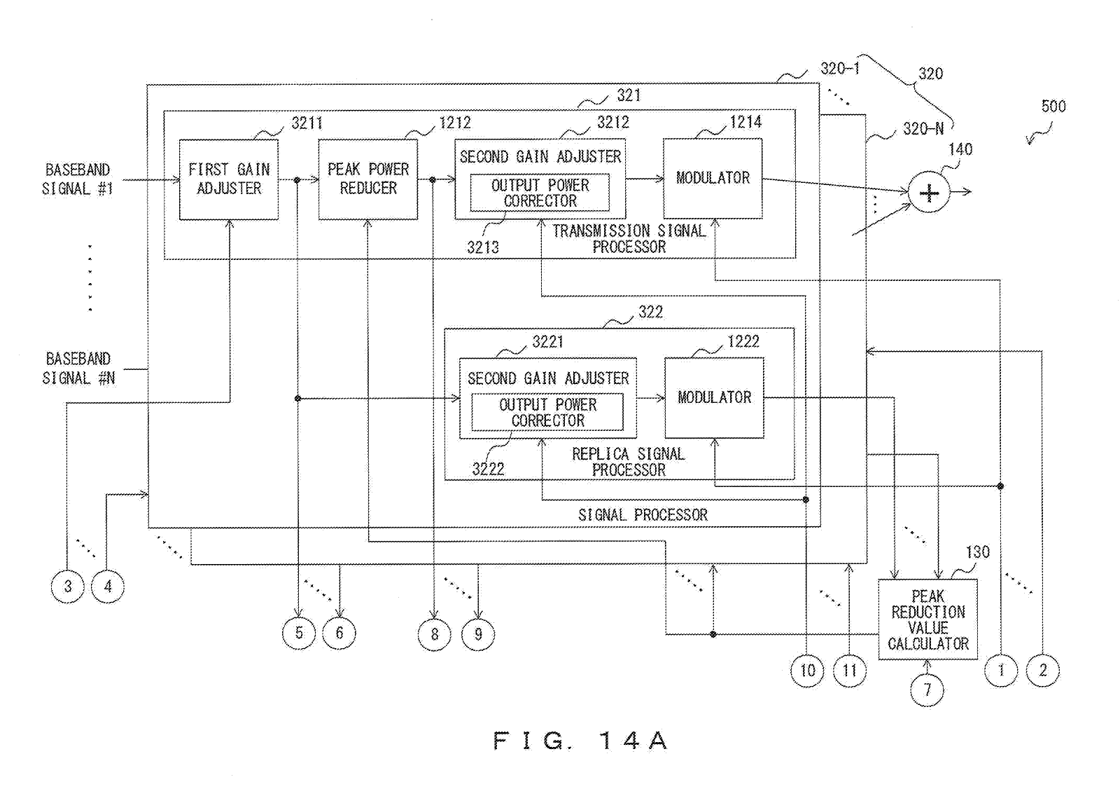

An example of the method for transmitting the multi-carrier signal executed by radio device 400 is explained. FIG. 13 is an exemplary illustration of the process flow for the transmission of a multi-carrier signal executed by the radio device according to the third embodiment. In the example illustrated in FIG. 13, control values set by the control processor 410 are the first gain adjustment value multiplied by the power correction value, the peak power threshold, and the carrier frequency. Meanwhile, in FIG. 13, the respective processes in step S3003, step S3004, and step S3005 may be performed in parallel in terms of time.

When a series of processes for transmitting a multi-carrier signal start (step S3001), the control processor 410 receives control information from a host device (step S3002). Specifically, the correction value obtaining unit 4114 receives the first gain adjustment value for the processing-target carrier signal and information of the carrier frequency of each carrier signal. The threshold reporting unit 112 receives information of the radio access technology for the transmission-target multi-carrier signal from the host device. The frequency reporting unit 113 receives the information of the carrier frequency of the processing-target carrier signal from the host device.

In step S3003, the threshold reporting unit 112 reports the peak power threshold according to the radio access technology to the peak reduction value calculator 130. The peak reduction value calculator 130 receives the peak power threshold from the threshold reporting unit 112. The peak reduction value calculator 130 sets the received peak power threshold as the power threshold for the multi-carrier signal in which carrier signals generated by the respective transmission signal processors 321 are multiplexed.

In step S3004, the frequency reporting unit 113 reports the value of the received carrier frequency to the modulators 1214, 1222 in the signal processor 120 provided for the corresponding carrier signal. The modulators 1214, 1222 receive the carrier frequency information of the processing-target carrier signal from the frequency reporting unit 113. The modulators 1214, 1222 set the carrier frequency information as the carrier frequency for modulating an input baseband signal.

In step S3005, the correction value obtaining unit 4114 calculates the occupied bandwidth of the multi-carrier signal by referring to the received information of the carrier frequencies and subtracting the lowest carrier frequency from the highest carrier frequency. The correction value obtaining unit 4114 obtains the power correction value according to the calculated occupied bandwidth from the power correction value table 4115 and holds the obtained power correction value. The correction value obtaining unit 4114 multiplies the received first gain adjustment value by the held power correction value. The correction value obtaining unit 4114 gives the first gain adjustment value multiplied by the power correction value to the first gain adjuster 1211 provided for the corresponding carrier signal.

The first gain adjuster 1211 receives the first gain adjustment value multiplied by the power correction value from the correction value obtaining unit 4114. The first gain adjuster 1211 sets the first gain adjustment value multiplied by the power correction value as the gain adjustment value to be adjusted by the corresponding first gain adjuster 1211 that includes the output power corrector 1215.

In step S3006, the radio device 400 starts the transmission of a multi-carrier signal according to the set control values. Specifically, the first gain adjuster 1211 receives baseband signals of carriers transmitted from the application. Then, the respective transmission signal processors 121 generate carrier signals according to the set control values. The carrier signals generated by the respective transmission signal processors 121 are combined by the combiner 140 and a multi-carrier signal is generated. The multi-carrier signal generated by the combiner 140 is transmitted via the antenna 190 after being subjected to the processes by the distortion compensator 150, the digital to analog converter 160, the radio frequency converter 170, and the power amplifier 180.

When the transmission of the multi-carrier signal starts, the processes in step S3007 through step S3014 are repeated a prescribed number of times M (M is an arbitrary integer equal to or larger than 1).

In step S3008, the first power calculator 4111 integrates over a prescribe period of time the power of the baseband signal of the carrier that is input to the peak power reducer 1212 provided for the same carrier signal as that for the first power calculator 4111 to calculate the first power. In step S3009, the second power calculator 4112 integrates over a prescribe period of time the power of the baseband signal of the carrier that is output from the peak power reducer 1212 provided for the same carrier signal as that for the second power calculator 4112 to calculate the second power.

In step S3010, the difference detector 4113 detects the difference between the first power calculated by the first power calculator 4111 in step S3008 and the second power calculated by the second power calculator 4112 in step S3009. The correction value obtaining unit 4114 obtains the difference value detected by the difference detector 4113. In step S3011, the correction value obtaining unit 4114 calculates the weighted average of the power difference value and the power correction value that has already been held, and the correction value obtaining unit 4114 holds the calculated value as a new power correction value. In step S3012, the correction value obtaining unit 4114 multiplies the first gain adjustment value received from the host device by the held power correction value. The correction value obtaining unit 4114 gives the first gain adjustment value multiplied by the power correction value to the first gain adjuster 1211 provided for the corresponding carrier signal.

In step S3013, the first gain adjuster 1211 receives the first gain adjustment value multiplied by the power correction value from the correction value obtaining unit 4114. The first gain adjuster 1211 sets the first gain adjustment value multiplied by the power correction value as the gain adjustment value to be adjusted by the corresponding first gain adjuster 1211 that includes the output power corrector 1215.

The series of processes are terminated when the transmission of the multi-carrier ends (step S3015).

As described above, with the radio device 400 according to the third embodiment, the error between the transmission output power of a carrier signal to which a peak power reduction process has been applied and the reference output power for the carrier signal is suppressed with a good accuracy in accordance with the occupied bandwidth of the multi-carrier signal. As a result, the accuracy of the transmission output power of each of carrier signals multiplexed in a multi-carrier signal further improves regardless of the width of the occupied bandwidth of the multi-carrier signal.

### Fourth Embodiment

In the second embodiment, the radio device suppresses the error between the transmission output power of a carrier signal to which a peak power reduction process has been applied and the reference output power for the carrier signal after the peak power reduction process is applied to the carrier signal. In addition, in the second embodiment, the radio device holds in advance the power correction value for each occupied bandwidth of the multi-carrier signal in order to correct such an error. However, the radio device may also be configured so as to generate the power correction value for the carrier signals multiplexed in the transmission-target multi-carrier signal while these carrier signals are being generated.

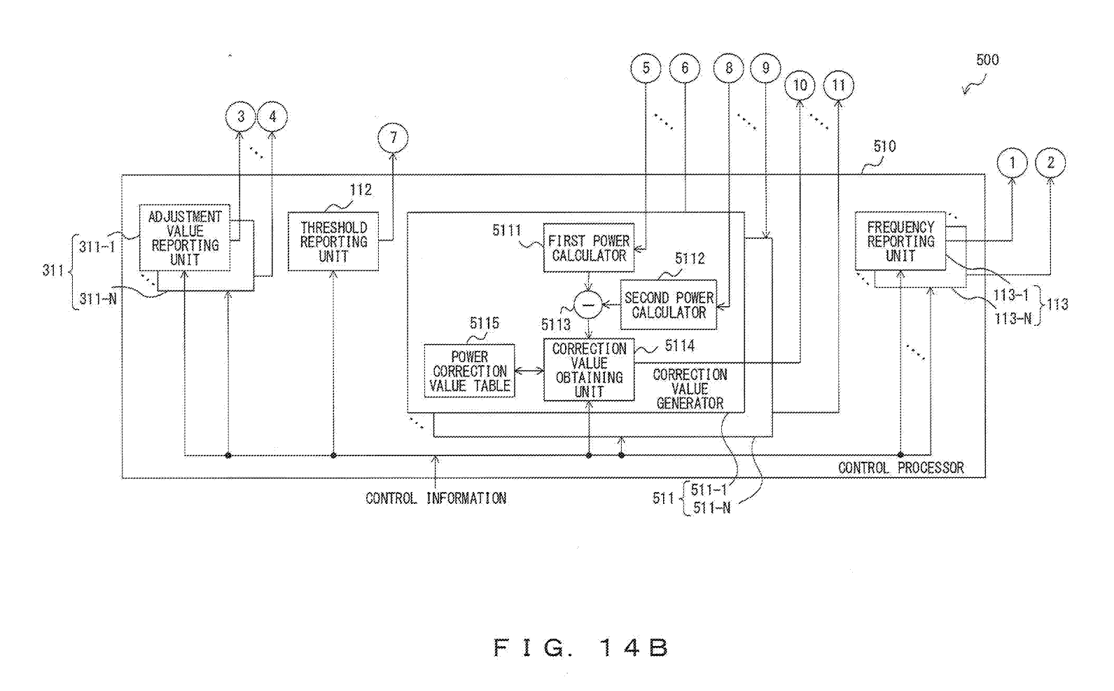

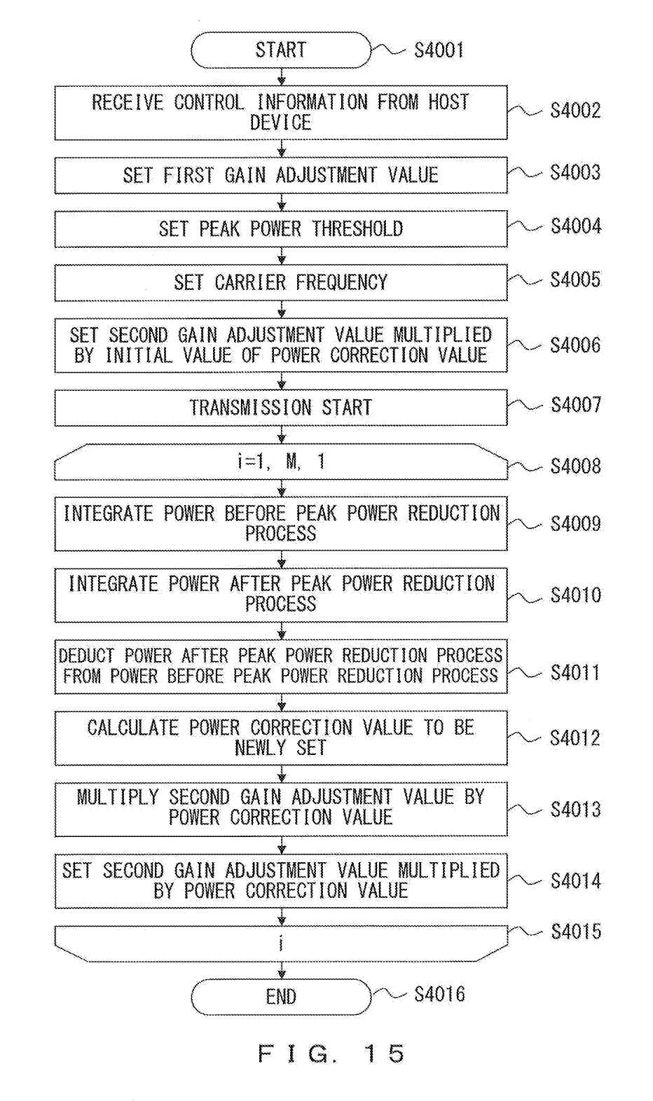

FIGS. 14A-14B are exemplary function configuration diagrams of a radio device according to the fourth embodiment. In FIGS. 14A-14B, in the circuit elements of a radio device 500 according to the fourth embodiment, the same circuit elements as those in the radio device 300 (see FIGS. 9A-9B) are indicated by the same reference numerals as the reference numerals of the circuit elements of the radio device 300. The radio device 500 is configured by hardware illustrated in FIG. 8, for example. Note that the distortion compensator 150, the DAC 160, the radio frequency converter 170, the power amplifier 180, and the antenna 190 are substantially the same in the first and fourth embodiments, and thus they are omitted in FIGS. 14A-14B.

As illustrated in FIGS. 14A-14B, the radio device 500 includes a control processor 510 instead of the control processor 310 (see FIG. 9B). The control processor 510 includes correction value generators 511-1 through 511-N instead of the correction value generators 312-1 through 312-2 (see FIG. 9B).

The correction value generator 511 holds the second gain adjustment value for the processing-target carrier signal in advance. In addition, the correction value generator 511 stores an initial value of the power correction value for the processing-target carrier signal, for each occupied bandwidth of the multi-carrier signal. For example, the correction value generator 511 holds a power correction value table such as the one illustrated in FIG. 3.

The correction value generator 511 receives information of the carrier frequency of each of the carrier signals multiplexed in the multi-carrier signal from a host device. The correction value generator 511 calculates the occupied bandwidth of the multi-carrier signal using the received information of each carrier frequency. The correction value generator 511 selects the initial value of the power correction value according to the calculated occupied bandwidth from the stored initial values of the power correction values. The correction value generator 511 holds the selected initial value of the power correction value as the power correction value to be used by the output power correctors 3213, 3222 in the signal processor 320 provided for the corresponding carrier signal. The correction value generator 511 multiplies the second gain adjustment value held in advance by the held power correction value. The correction value generator 511 gives the second gain adjustment value multiplied by the power correction value to the second gain adjusters 3212, 3221 in the signal processor 320 provided for the corresponding carrier signal.

Meanwhile, after the transmission of the multi-carrier signal starts, the correction value generator 511 generates the power correction value using the difference value between the first power and the second power. As described earlier, it can be said that the power correction value calculated using the difference value between the first power and the second power is a value generated according to the occupied bandwidth of the multi-carrier signal. For example, the correction value generator 411 calculates the weighted average of the difference value between the first power and the second power and the power correction value that has already been held. The correction value generator 411 holds the newly generated power correction value.

The correction value generator 511 multiplies the second gain adjustment value held in advance by the held power correction value. The correction value generator 511 gives the second gain adjustment value multiplied by the power correction value to the second gain adjusters 3212, 3221 in the signal processor 320 provided for the corresponding carrier signal.

Meanwhile, the generation process for the power correction value after the start of the transmission of the multi-carrier signal may be repeated a prescribed number of times at a prescribed time interval. With the repeated execution of the generation process for the power correction value, it becomes possible to improve the accuracy in suppressing the error between the transmission output power of a carrier signal to which a peak power reduction process has been applied and the reference output power for the carrier signal.

As described above, the correction value generator 511 has a similar function as that of the correction value generator 312 in generating a power correction value and giving the second gain adjustment value multiplied by the generated power correction value to the second gain adjusters 3212, 3221. However, the correction value generator 511 differs from the correction value generator 312 in that, after the start of the transmission of the multi-carrier signal, the correction value generator 511 generates the power correction value using the power of the carrier signal before the peak power reduction process and the power of the carrier signal after the peak power reduction process.

The correction value generators 511-1 through 511-N respectively include a first power calculator 5111, a second power calculator 5112, a difference detector 5113, a correction value obtaining unit 5114, and a power correction value table 5115.

The correction value obtaining unit 5114 holds the second gain adjustment value for the processing-target carrier signal in advance. The correction value obtaining unit 5114 receives information of the carrier frequency of each of the carrier signals multiplexed in the multi-carrier signal from a host device. The correction value obtaining unit 5114 calculates the occupied bandwidth of the multi-carrier signal by referring to the received information of the carrier frequencies and subtracting the lowest carrier frequency from the highest carrier frequency. The correction value obtaining unit 5114 obtains the power correction value according to the calculated occupied bandwidth from the power correction value table 5115. The power correction value table 5115 is a table such as the one illustrated in FIG. 3 for example. The correction value obtaining unit 5114 holds the obtained power correction value. The correction value obtaining unit 5114 multiplies the second gain adjustment value held in advance by the held power correction value. The correction value obtaining unit 5114 gives the second gain adjustment value multiplied by the power correction value to the second gain adjusters 3212, 3221, in the signal processor 320 provided for the corresponding carrier signal.

After the start of the transmission of the multi-carrier signal, the first power calculator 5111 calculates the first power of the processing-target carrier signal from the baseband signal of the carrier that is input to the peak power reducer 1212 provided for the corresponding carrier signal. The second power calculator 5112 calculates the second power of the processing-target carrier signal from the baseband signal of the carrier that is output from the peak power reducer 1212 provided for the corresponding carrier signal. The difference detector 5113 detects the difference between the first power calculated by the first power calculator 5111 and the second power calculated by the second power calculator 5112. The correction value obtaining unit 5114 obtains the power difference value detected by the difference detector 5113. The correction value obtaining unit 5114 calculates the weighted average of the obtained power difference value and the power correction value that has already been held. The correction value obtaining unit 5114 holds the calculated value as a new power correction value. The correction value obtaining unit 5114 multiplies the second gain adjustment value held in advance by the held power correction value. The correction value obtaining unit 5114 gives the second gain adjustment value multiplied by the power correction value to the second gain adjusters 3212, 3221 in the signal processor 320 provided for the corresponding carrier signal.

As described above, the correction value generator 511 generates the power correction value that is to be reported to the output power corrector 3213 without holding it in advance. In addition, the correction value generator 511 generates the power correction value using the baseband signals of carriers that are actually processed by the signal processors 320, and therefore, the power correction value is generated with a good accuracy.

The second gain adjuster 3212 receives the power correction value multiplied by the second gain adjustment value from the correction value obtaining unit 5114. The second gain adjuster 3212 adjusts the power of an input carrier signal so that the digital to analog converter 160 operates at the optimal operation point, according to the power correction value multiplied by the second gain adjustment value. That is, the second gain adjuster 3212 adjusts the power of the baseband signal of the processing-target carrier treated with the correction process by the output power corrector 3213. Note that the second gain adjuster 3221 operates in a manner similar to that of the second gain adjuster 3212.

Meanwhile, the correction value obtaining unit 5114 may also be configured so as to give the power correction value and the second gain adjustment value separately to the second gain adjuster 3212 provided for the corresponding carrier signal. In this case, the second gain adjuster 3212 may also be configured so as to increase the power of an input baseband signal of a carrier according to the received second gain adjustment value. The output power corrector 3213 included in the second gain adjuster 3212 may also be configured to correct the output power of the baseband signal of the carrier increased in accordance with the second gain adjustment value, according to the received power correction value. The second gain adjuster 3221 and the output power corrector 3222 may also be configured so as to operate in a manner similar to that of the second gain adjuster 3212 and the output power corrector 3213.

Through the processes performed by the correction value generator 511 and the output power corrector 3213 described above, the error between the transmission output power of a carrier signal to which a peak power reduction process has been applied and the reference output power for the carrier signal is suppressed in accordance with the width of the occupied bandwidth of the multi-carrier signal. As a result, the accuracy of the transmission output power of each of carrier signals multiplexed in a multi-carrier signal improves regardless of the width of the occupied bandwidth of the multi-carrier signal.

Meanwhile, described above is merely a configuration example of the radio device according to the fourth embodiment, and the radio device according to the fourth embodiment may also be configured so as to execute the processes described below. That is, the control processor 510 associates and stores the power correction value generated by the correction value generator 511 with the occupied bandwidth of the multi-carrier signal to be transmitted. The control processor 510 calculates the bandwidth of the multi-carrier signal to be transmitted using information of carrier frequencies newly reported from a host device. The control processor 510 decides whether the power correction value corresponding to the calculated bandwidth has already been stored. When it is decided that the power correction value corresponding to the calculated bandwidth has already been stored, the control processor 510 reports the power correction value corresponding to the calculated occupied bandwidth to the second gain adjusters 3212, 3221. When it is decided that the power correction value corresponding to the calculated bandwidth has not been stored, the control processor 510 generates a power correction value corresponding to the calculated occupied bandwidth through the process performed by the correction value generator 511, and reports the generated power correction value to the second gain adjusters 3212, 3221. According to such a configuration, the radio device 500 does not need to generate the power correction value every time information of the carrier frequency is newly reported from the host device. As a result, according to the configuration described above, it becomes possible to further speed up and simplify the process for suppressing the error between the transmission output power of a carrier signal to which a peak power reduction process has been applied and the reference output power for the carrier signal in accordance with the occupied bandwidth of the multi-carrier signal.

Meanwhile, in the description above, the correction value obtaining unit 5114 obtains, from the power correction value table 5115, the power correction value at the time of the start of transmission. However, the radio device 500 may be configured so as not to include the power correction value table 5115, and the correction value obtaining unit 5114 may be configured so as to hold a default value as the power correction value at the time of the start of transmission. According to such a configuration, during the transmission of the multi-carrier signal, the error between the transmission output power of a carrier signal to which a peak power reduction process has been applied and the reference output power for the carrier signal is also suppressed in accordance with the occupied bandwidth of the multi-carrier signal.

An example of the method for transmitting the multi-carrier signal executed by the radio device 500 is explained. FIG. 15 is an exemplary illustration of the process flow for the transmission of a multi-carrier signal executed by the radio device according to the fourth embodiment. In the example illustrated in FIG. 15, control values generated by the control processor 510 are the first gain adjustment value, the peak power threshold, the carrier frequency, and the second gain adjustment value multiplied by the power correction value. Meanwhile, in FIG. 15, the respective processes in step S4003, step S4004, and step S4005 may be performed in parallel in terms of time.

When a series of processes for transmitting a multi-carrier signal start (step S4001), the control processor 510 receives control information from a host device (step S4002). Specifically, the adjustment value reporting unit 311 receives the first gain adjustment value for the processing-target carrier signal from the host device. The threshold reporting unit 112 receives information of the radio access technology for the transmission-target multi-carrier signal from the host device. The correction value obtaining unit 5114 receives information of the carrier frequency of each of the carrier signals multiplexed in the multi-carrier signal from the host device. The frequency reporting unit 113 receives information of the carrier frequency of the processing-target carrier signal from the host device.

In step S4003, the adjustment value reporting unit 311 gives the received first gain adjustment value to the first gain adjuster 3211 provided for the corresponding carrier signal. The first gain adjuster 3211 receives the first gain adjustment value for the processing-target carrier signal from the adjustment value reporting unit 311. The first gain adjuster 3211 sets the received first gain adjustment value as the value for adjusting the power of an input baseband signal of a carrier to the prescribed reference output power for the carrier signal.

In step S4004, the threshold reporting unit 112 reports the prescribed peak power threshold according to the radio access technology to the peak reduction value calculator 130. The peak reduction value calculator 130 receives the peak power threshold from the threshold reporting unit 112. The peak reduction value calculator 130 sets the received peak power threshold as the power threshold for the multi-carrier signal in which carrier signals generated by the respective transmission signal processors 121 are multiplexed.

In step S4005, the frequency reporting unit 113 reports the value of the carrier frequency to the modulators 1214, 1222 in the signal processor 320 provided for the corresponding carrier signal. The modulators 1214, 1222 receive the carrier frequency information of the processing-target carrier signal from the frequency reporting unit 113. The modulators 1214, 1222 sets the received carrier frequency information as the carrier frequency for modulating an input baseband signal.

In step S4006, the correction value obtaining unit 5114 calculates the occupied bandwidth of the multi-carrier signal by referring to the received information of the carrier frequencies and subtracting the lowest carrier frequency from the highest carrier frequency. The correction value obtaining unit 5114 obtains the power correction value according to the calculated occupied bandwidth from the power correction value table 5115, and the correction value obtaining unit 5114 holds the obtained power correction value. The correction value obtaining unit 5114 multiplies the received second gain adjustment value by the held power correction value. The correction value obtaining unit 5114 gives the second gain adjustment value multiplied by the power correction value to the second gain adjusters 3212, 3221 provided for the corresponding carrier signal.

The second gain adjuster 3212 receives the second gain adjustment value multiplied by the power correction value from the correction value obtaining unit 5114. The second gain adjuster 3212 sets the second gain adjustment value multiplied by the power correction value as the gain adjustment value to be adjusted by this second gain adjuster 3212 that includes the output power corrector 3213. The second gain adjuster 3221 operates in a manner similar to that of the second gain adjuster 3212 to set the second gain adjustment value multiplied by the power correction value.

In step S4007, the radio device 500 starts the transmission of a multi-carrier signal according to the set control values. Specifically, the first gain adjuster 3211 receives baseband signals of carriers transmitted from the application. Then, the respective transmission signal processors 321 generate carrier signals according to the set control values. The carrier signals generated by the respective transmission signal processors 321 are combined by the combiner 140, and a multi-carrier signal is generated. The multi-carrier signal generated by the combiner 140 is transmitted via the antenna 190 after being subjected to the processes by the distortion compensator 150, the digital to analog converter 160, the radio frequency converter 170, and the power amplifier 180.

When the transmission of the multi-carrier signal starts, the processes in step S4008 through step S4015 are repeated a prescribed number of times M (M is an arbitrary integer equal to or larger than 1).

In step S4009, the first power calculator 5111 integrates over a prescribe period of time the power of the baseband signal of the carrier that is input to the peak power reducer 1212 provided for the same carrier signal as that for the first power calculator 5111 to calculate the first power. In step S4010, the second power calculator 5112 integrates over a prescribe period of time the power of the baseband signal of the carrier that is output from the peak power reducer 1212 provided for the same carrier signal as that for the second power calculator 5112 to calculate the second power.

In step S4011, the difference detector 5113 detects the difference between the first power calculated by the first power calculator 5111 in step S4009 and the second power calculated by the second power calculator 5112 in step S4010. The correction value obtaining unit 5114 obtains the power difference value detected by the difference detector 5113. In step S4012, the correction value obtaining unit 5114 calculates the weighted average of the obtained power difference value and the held power correction value, and the correction value obtaining unit 5114 holds the calculated value as a new power correction value. In step S4013, the correction value obtaining unit 5114 multiplies the second gain adjustment value held in advance with the held power correction value. The correction value obtaining unit 5114 gives the second gain adjustment value multiplied by the power correction value to the second gain adjusters 3212, 3221 provided for the corresponding carrier signal.

In step S4014, the second gain adjuster 3212 receives the second gain adjustment value multiplied by the power correction value from the correction value obtaining unit 5114. The second gain adjuster 3212 sets the second gain adjustment value multiplied by the power correction value as the gain adjustment value to be adjusted by this second gain adjuster 3212 that includes the output power corrector 3213. The second gain adjuster 3221 sets the second gain adjustment value multiplied by the power correction value through an operation similar to that of the second gain adjuster 3212.

The series of processes are terminated when the transmission of the multi-carrier ends (step S4016).

As described above, with the radio device 500 according to the fourth embodiment, the error between the transmission output power of a carrier signal to which a peak power reduction process has been applied and the reference output power for the carrier signal is suppressed in accordance with the occupied bandwidth of the multi-carrier signal with a good accuracy. As a result, the accuracy of the transmission output power of each of the carrier signals multiplexed in the multi-carrier signal further improves regardless of the width of the occupied bandwidth of the multi-carrier signal.

As described above, with a radio device according to an aspect of the embodiments, while reducing the peak power of a multi-carrier signal in which a plurality of carrier signals are multiplexed, the accuracy of the transmission output power of each of the carrier signals may be improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A radio device comprising:
a peak power reducer that reduces, according to a peak power of a multi-carrier signal obtained by a multiplexing of a plurality of carrier signals, a gain of the carrier signals before the multiplexing; and
an output power corrector that corrects a power of the carrier signals before the multiplexing using a power correction value according to an occupied bandwidth of the multi-carrier signal.

2. The radio device according to claim 1, further comprising:
a power correction value table in which the power correction value is stored with respect to occupied bandwidth of the multi-carrier signal; and
a correction value obtaining unit that calculates an occupied bandwidth of the multi-carrier signal using information of carrier frequencies corresponding to the carrier signals, obtains a power correction value corresponding to the calculated occupied bandwidth from the power correction value table, and reports the obtained power correction value to the output power corrector.

3. The radio device according to claim 2, wherein
the correction value obtaining unit receives, from a host device of the radio device, a first gain adjustment value for adjusting the gain of the carrier signals so that a transmission output power of the multi-carrier signal becomes a prescribed reference output power for the multi-carrier signal, multiplies the received first gain adjustment value by the obtained power correction value, and gives the first gain adjustment value multiplied by the power correction value to the output power corrector, and
the output power corrector receives the first gain adjustment value multiplied by the power correction value from the correction value obtaining unit, and corrects the power of the carrier signals whose peak power has not been reduced by the peak power reducer, using the received power correction value.

4. The radio device according to claim 2, wherein
the correction value obtaining unit holds a second gain adjustment value for adjusting the gain of the carrier signals so that the multi-carrier signal before being converted into radio frequency is converted from digital to analog at an optimal operation point of a digital to analog converter, multiples the second gain adjustment value by the obtained power correction value, and gives the second gain adjustment value multiplied by the power correction value to the output power corrector, and
the output power corrector receives the second gain adjustment value multiplied by the power correction value from the correction value obtaining unit, and corrects the power of the carrier signals whose peak power has been reduced by the peak power reducer, using the received power correction value.

5. The radio device according to claim 1, further comprising:
a power correction value table in which the power correction value multiplied by a second gain adjustment value for adjusting the gain of the carrier signals so that the multi-carrier signal before being converted into radio frequency is converted from digital to analog at an optimal operation point of a digital to analog converter is recorded with respect to occupied bandwidth of the multi-carrier signal; and
a correction value obtaining unit that calculates an occupied bandwidth of the multi-carrier signal using information of carrier frequencies corresponding to the carrier signals, obtains a power correction value corresponding to the calculated occupied bandwidth from the power correction value table, and reports the obtained power correction value to the output power corrector, wherein
the output power corrector receives the power correction value multiplied by the second gain adjustment value from the correction value obtaining unit, and corrects the power of the carrier signals whose peak power has been reduced by the peak power reducer, using the received power correction value.

6. The radio device according to claim 1, further comprising:
a first power calculator that calculates a first power of the carrier signals whose peak power has not been reduced by the peak power reducer;
a second power calculator that calculates a second power of the carrier signals whose peak power has been reduced by the peak power reducer;
a difference detector that detects a difference between the first power calculated by the first power calculator and the second power calculated by the second power calculator; and
a correction value obtaining unit that obtains a power correction value according to the occupied bandwidth of the multi-carrier signal based on the difference detected by the difference detector.

7. The radio device according to claim 6, wherein
the correction value obtaining unit receives, from a host device of the radio device, a first gain adjustment value for adjusting the gain of the carrier signals so that a transmission output power of the multi-carrier signal becomes a prescribed reference output power for the multi-carrier signal, multiplies the received first gain adjustment value by the obtained power correction value, and gives the first gain adjustment value multiplied by the power correction value to the output power corrector, and
the output power corrector receives the first gain adjustment value multiplied by the power correction value from the correction value obtaining unit, and corrects the power of the carrier signals whose peak power has not been reduced by the peak power reducer, using the received power correction value.

8. The radio device according to claim 6, wherein
the correction value obtaining unit holds a second gain adjustment value for adjusting the gain of the carrier signals so that the multi-carrier signal before being converted into radio frequency is converted from digital to analog at an optimal operation point of a digital to analog converter, multiples the second gain adjustment value by the obtained power correction value, and gives the second gain adjustment value multiplied by the power correction value to the output power corrector, and
the output power corrector receives the second gain adjustment value multiplied by the power correction value from the correction value obtaining unit, and corrects the power of the carrier signals whose peak power has been reduced by the peak power reducer, using the received power correction value.
